(19) United States
(12) Patent Application Publication
(10) Pub. No.: US 2025/0035824 A1
(43) Pub. Date: Jan. 30, 2025

(54) OPTICAL DEVICE FOR HOMOGENIZING AND DIFFUSING LIGHT, EMITTING TERMINAL AND OPTICAL SYSTEM

(71) Applicant: Ningbo Sunny Automotive Optech Co, Ltd., Ningbo City (CN)

(72) Inventors: Jia YANG, Ningbo City (CN); Chao XU, Ningbo City (CN); Junming ZHANG, Ningbo City (CN); Xiang LI, Ningbo City (CN); Hao ZHANG, Ningbo City (CN)

(21) Appl. No.: 18/782,509

(22) Filed: Jul. 24, 2024

(30) Foreign Application Priority Data
Jul. 24, 2023 (CN) 202310913815.8
Jul. 24, 2023 (CN) 202310913857.1
Jul. 24, 2023 (CN) 202310915266.8
Jul. 24, 2023 (CN) 202310916373.2

(51) Int. Cl. G02B 3/00; G01S 7/481

(52) U.S. Cl. CPC G02B 3/0062; G01S 7/4814; G01S 7/4817

(57) ABSTRACT

An optical device for homogenizing and diffusing light, an emitting terminal and optical system are provided. An implementation of the optical device for homogenizing and diffusing light includes: a microlens array element, the microlens array element homogenizing and diffusing a light beam in a first direction, a second direction, or a first direction and a second direction, to form a homogeneous light beam, wherein the first direction and the second direction are perpendicular to each other.

### CROSS-REFERENCE TO RELATED APPLICATIONS

This patent application claims priorities to four Chinese patent applications filed on Jul. 24, 2023 with the Application Nos. 202310913815.8, 202310915266.8, 202310913857.1, 202310916373.2, respectively, which are incorporated herein by reference in their entirety.

### TECHNICAL FIELD

The present application relates to the field of optical technology, in particular to an optical device for homogenizing and diffusing light, emitting terminal and optical system.

### BACKGROUND

With the rapid development of intelligent autonomous driving, optical systems are expected to improve ranging drawbacks of cameras and millimetre-wave radars, and have become the core sensors in autonomous driving. Lidar may acquire information such as distance and speed of a target with high precision and accuracy or realize target imaging, which plays an important role in fields such as roadblock detection, mapping, navigation, etc., and is widely used in aerospace. Scanning systems used mainly include point scanning, line scanning and surface scanning.

### SUMMARY

Embodiments of the present disclosure provide an optical device for homogenizing and diffusing light, an emitting terminal and optical system, a method for manufacturing an optical system, a lidar system adopting the optical system and a laser scanning method.

Some embodiments of the present disclosure provide an optical device for homogenizing and diffusing light, which comprises a microlens array element, the microlens array element homogenizing and diffusing a light beam in a first direction, a second direction, or a first direction and a second direction, to form a homogeneous light beam, wherein the first direction and the second direction are perpendicular to each other.

Some embodiments of the present disclosure provide an emitting terminal, the emitting terminal comprises a light source, configured to emit a light beam for detecting a target object; and an optical device for homogenizing and diffusing light, configured to process the light beam emitted by the light source to obtain a diffused homogeneous beam.

Some embodiments of the present disclosure provide an optical system, which includes the emitting terminal described above and a receiving terminal which comprises a detection array element, the detection array element receiving reflected light of the homogeneous beam.

Some embodiments of the present disclosure provide an optical system, including an emitting module, the emitting module including a light source and a microlens array element arranged in sequence along an optical axis from a first side to a second side, the microlens array element diffusing and homogenizing a light beam emitted by the light source in a first direction and/or a second direction to form a homogeneous light beam, where, the first direction and the second direction are perpendicular to each other, and are both perpendicular to the optical axis.

Some embodiments of the present disclosure provide a method for manufacturing an optical system, including: setting an emitting module, the emitting module including a light source and a microlens array element arranged in sequence along an optical axis from a first side to a second side; and setting a receiving module, the receiving module including a detection array element, where, the method for manufacturing further includes: diffusing and homogenizing a light beam emitted by the light source in a first direction and/or a second direction using the microlens array element to form a homogeneous light beam, where the first direction and the second direction are perpendicular to each other and are both perpendicular to the optical axis; and receiving reflected light of the homogeneous beam using the detection array element.

Some embodiments of the present disclosure provide an optical system, including: a light source, configured to emit an area light beam for detecting a target object; and at least one microlens array, configured to homogenize and diffuse the light beam, each of the microlens array including a plurality of microlens units, and the plurality of microlens units being arranged and set correspondingly based on a homogenizing and diffusing direction of the area beam.

Some embodiments of the present disclosure provide a lidar system, including: an optical system as described in any one of the foregoing; a receiving terminal, for receiving the area light beam reflected by the target object, an area of the area light beam received by the receiving terminal being not smaller than an area of the area light beam emitted by the optical system; where, the receiving terminal includes a receiving terminal lens assembly and a receiving chip; the receiving terminal lens assembly, is configured to converge the area light beam reflected by the target object, and the receiving terminal lens assembly is co-distortion with an emitting terminal lens assembly in the optical system; and the receiving chip, is configured to detect and receive the focused area beam.

Some embodiments of the present disclosure provide a lidar scanning method, using a lidar system as described in any one of the above embodiments, the method including: controlling a light source of the lidar system to emit an area beam of a preset shape.

### BRIEF DESCRIPTION OF THE DRAWINGS

Other features, objectives, and advantages in embodiments of the present disclosure will become more apparent from the following detailed description of non-limiting embodiments with reference to the accompanying drawings. In which:

FIG. 1 shows a schematic structure diagram of an optical system according to some example embodiments of the present disclosure;

FIG. 2 shows a schematic structure diagram of an emitting module according to some example embodiments of the present disclosure;

FIG. 3 shows a schematic structure diagram of the emitting module according to some example embodiments of the present disclosure;

FIG. 4 shows a schematic structure diagram of the emitting module according to some example embodiments of the present disclosure;

FIG. 5 shows a schematic structure diagram of the emitting module according to some example embodiments of the present disclosure;

FIG. 6 shows a schematic structure diagram of a first microlens array element according to some example embodiments of the present disclosure;

FIG. 7 shows a schematic structure diagram of a second microlens array element according to some example embodiments of the present disclosure;

FIG. 8 shows a schematic structure diagram of a microlens array element according to some example embodiments of the present disclosure;

FIG. 9 shows a schematic structure diagram of a microlens array element according to some example embodiments of the present disclosure;

FIG. 10A and FIG. 10B show schematic diagrams of a light source and a light illuminated area of a detection array element according to some example embodiments of the present disclosure;

FIG. 11 shows a schematic structure diagram of a light resource according to some example embodiments of the present disclosure;

FIG. 12 shows a schematic structure diagram of the light resource according to some example embodiments of the present disclosure; and

FIG. 13 shows a schematic structure diagram of the light resource according to some example embodiments of the present disclosure.

FIG. 14 shows a schematic diagram of an application scenario of an emitting terminal provided by some other example embodiments of the present disclosure;

FIG. 15 shows a schematic structure diagram I of an emitting terminal provided by some other example embodiments of the present disclosure;

FIG. 16 shows a schematic structure diagram I of an optical system provided by some other example embodiments of the present disclosure;

FIG. 17 shows a schematic structure diagram of a light source provided by some other example embodiments of the present disclosure;

FIG. 18 shows a schematic structure diagram II of an emitting terminal provided by some other example embodiments of the present disclosure;

FIG. 19 shows a schematic diagram I of a lit state of a light source and a receiving chip of an optical system provided by some other example embodiments of the present disclosure;

FIG. 20 shows a schematic diagram II of a lit state of a light source and a receiving chip of the optical system provided by some other example embodiments of the present disclosure;

FIG. 21 shows a schematic structure diagram of a two-dimensional microlens array provided by some other example embodiments of the present disclosure;

FIG. 22 shows a schematic diagram III of a lit state of a light source and a receiving chip of the optical system provided by some other example embodiments of the present disclosure;

FIG. 23 shows a schematic structure diagram II of the optical system provided by some other example embodiments of the present disclosure;

FIG. 24 shows a schematic structure diagram III of an optical system provided by some other example embodiments of the present disclosure;

FIG. 25 shows a schematic structure diagram III of an emitting terminal provided by some other example embodiments of the present disclosure;

FIG. 26 shows a schematic structure diagram IV of an optical system provided by some other example embodiments of the present disclosure;

FIG. 27 shows a schematic diagram IV of a lit state of a light source and a receiving chip of the optical system provided by some other example embodiments of the present disclosure;

FIG. 28 shows a schematic diagram of an application scenario of an optical system provided by some further example embodiments of the present disclosure;

FIG. 29 shows a schematic structure diagram I of an optical system provided by some further example embodiments of the present disclosure;

FIG. 30 shows a schematic structure diagram of a microlens array provided by some further example embodiments of the present disclosure;

FIG. 31 shows a schematic structure diagram II of an optical system provided by some further example embodiments of the present disclosure;

FIG. 32 shows a schematic structure diagram of a lidar system provided by some further example embodiments of the present disclosure;

FIG. 33 shows a schematic diagram I of a lit relationship between a light source and a receiving chip in a lidar system provided by some further example embodiments of the present disclosure;

FIG. 34 shows a schematic diagram II of a lit relationship between a light source and a receiving chip in the lidar system provided by some further example embodiments of the present disclosure;

FIG. 35 shows a schematic diagram I of a light source lit position in the lidar system provided by some further example embodiments of the present disclosure;

FIG. 36 shows a schematic diagram II of a light source lit position in the lidar system provided by some further example embodiments of the present disclosure;

FIG. 37 shows a schematic diagram III of a light source lit position in the lidar system provided by some further example embodiments of the present disclosure;

FIG. 38 shows a schematic diagram IV of a light source lit position in the lidar system provided by some further example embodiments of the present disclosure;

FIG. 39 shows a schematic diagram V of a light source lit position in the lidar system provided by some further example embodiments of the present disclosure;

FIG. 40 shows a schematic diagram of a relationship between a light source lit position and a light signal received by a receiving chip in the lidar system provided by some further example embodiments of the present disclosure;

FIG. 41 shows a schematic diagram of a corresponding relationship between a light source lit region and a receiving chip lit area in the lidar system provided by some further example embodiments of the present disclosure;

FIG. 42 shows a simulation diagram of energy level distribution received by a receiving chip of an existing lidar system;

FIG. 43 shows a schematic diagram VI of a light source lit position in the lidar system provided by some further example embodiments of the present disclosure;

FIG. 44 shows a schematic diagram of an application scenario of an optical device for homogenizing and diffusing light provided by some further example embodiments of the present disclosure;

FIG. 45 shows a schematic structure diagram I of an optical device for homogenizing and diffusing light provided by some further example embodiments of the present disclosure;

FIG. 46 shows a schematic structure diagram II of an optical device for homogenizing and diffusing light provided by some further example embodiments of the present disclosure;

FIG. 47 shows a schematic diagram of a partial structure of a block microlens unit provided by some further example embodiments of the present disclosure;

FIG. 48 shows a schematic diagram of horizontal position of central points of an arrangement of a plurality of microlens units provided by some further example embodiments of the present disclosure;

FIG. 49 shows a schematic structure diagram I of an optical system for homogenizing and diffusing light provided by some further example embodiments of the present disclosure;

FIG. 50 shows a schematic structure diagram II of an optical system for homogenizing and diffusing light provided by some further example embodiments of the present disclosure;

FIG. 51 shows a schematic structure diagram III an optical system for homogenizing and diffusing light provided by some further example embodiments of the present disclosure;

FIG. 52 shows a schematic structure diagram IV of an optical system for homogenizing and diffusing light provided by some further example embodiments of the present disclosure;

FIG. 53 shows a schematic structure diagram V of an optical system for homogenizing and diffusing light provided by some further example embodiments of the present disclosure;

FIG. 54 shows a schematic structure diagram VI of an optical system for homogenizing and diffusing light provided by some further example embodiments of the present disclosure; and

FIG. 55 shows a schematic structure diagram VII of an optical system for homogenizing and diffusing light provided by some further example embodiments of the present disclosure.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements. The expression “and/or” includes any and all combinations of one or more of the associated listed items.

It should be noted that, in the description of this specification, the expressions such as “first,” and “second” are only used to distinguish one feature from another, rather than represent any limitations to the features. Thus, the first direction discussed below may also be referred to as the second direction and the first side may be referred to as the second side, without departing from the teachings of the present disclosure. The surface of each component (e.g., a light source, a microlens array element, or an emitting optical element) closest to the first side is referred to as a first side of the component, and the surface closest to the second side is referred to as a second side of the component.

In the description of this specification, description of reference terms such as “an embodiment”, “some embodiments”, “schematic embodiments”, “examples”, “specific examples”, or “some examples” means that specific features, structures, materials, or characteristics described in conjunction with the embodiment or example are included in at least one embodiment or example of the present disclosure. In this specification, schematic expressions of the above terms do not necessarily refer to the same embodiment or example. Moreover, the specific features, structures, materials, or characteristics described may be combined in any one or more of the embodiments or examples in an appropriate way.

It may be understood by those of ordinary skill in the art that, in the description of the embodiments of the present disclosure, the term “and/or” indicates only one kind of association relationship describing associated objects, and indicates that three kinds of relationships may exist, for example, A and/or B, which may indicate: the existence of A alone, the existence of both A and B, and the existence of B alone. In addition, the term “at least one” indicates any one of a plurality or any combination of at least two of a plurality, e.g., including at least one of A, B, C may indicate any one or more elements selected from a set that includes A, B, and C in communication. In addition, the term “plurality” means two or more, unless otherwise precisely specified.

It should be further understood that the terms “comprising,” “including,” “having,” and/or “configured with,” when used in the specification, specify the presence of stated features, elements and/or components, but do not exclude the presence of one or more other features, elements, components and/or combinations thereof. In addition, the term “exemplary” is intended to refer to an example or illustration.

In the accompanying drawings, the thicknesses, sizes and shapes of components may be slightly exaggerated for the convenience of explanation. The accompanying drawings are merely illustrative and are not strictly scaled.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that embodiments in the present disclosure and the features in the embodiments may be combined with each other on a non-conflict basis. Embodiments of the present disclosure will be described below in detail with reference to the accompanying drawings.

Conventional optical systems typically match a receiving terminal and an emitting terminal in a point-to-point or single line-to-point approach, and in order to match a detection element at the receiving terminal, a light source at the emitting terminal is usually set up as a light source having a large light-emitting area. The large light-emitting area light source needs to be matched with a larger emitting optical element, which results in a large-volume and costly optical system. Moreover, the large light-emitting area light source requires a more complex drive circuit to drive, which results in a complex design of the drive circuit.

Conventional optical systems emit discrete dotted lines at the emitting terminal, which results in dark zones between rows or between columns in an emitting area, leading to dark zones in a detection area at the receiving terminal and missing of part of detection information, which seriously affects a detection efficiency of the optical systems.

The existing progressive scanning method can avoid the problem of scanning information missing, however, stray light may be caused by emission between structural components and lenses, and between lenses to each other, signal crosstalk caused by the stray light may interfere with and cause some of effective signals in reflected light signals to be annihilated, affecting the detection accuracy as well as sensitivity of the system.

In addition, fields such as machine vision, mobile electronic devices, projection, or lidar have increasingly high requirements on an irradiation range, which is mainly determined by light output energy and light output homogeneity of an optical device for homogenizing light. Commonly used optical device for homogenizing light include diffusers and diffraction light-homogenizing elements. Here, the diffuser is commonly used in a floodlighting system, after homogenizing by the diffuser, due to a refractive effect of the diffuser, the light source may cause light signal weakening, and the light output energy decreases, which leads to a weak return light signal, such as when used in a detection system, then there is not enough information to be recovered and energy utilisation is low; and light emitted by the diffraction light-homogenizing element is a dot matrix, although through special design, it can make most of the energy emitted by a point light source be received by a light-sensitive area, the diffraction light-homogenizing element also brings stray light while homogenizing light, which leads to the annihilation of effective signals, at the same time, limited by the diffraction characteristics, energy homogeneity passing through the diffraction light-homogenizing element is low, which decreases a matching efficiency of the whole system. In other words, after the light source is homogenized by the existing optical device for homogenizing light, it is not possible to achieve both a low loss of light output energy and homogeneity of light output, thus the irradiation range of an emitting device cannot be improved.

In order to at least partially solve one or more of the above problems and other potential problems, some embodiments of the present disclosure propose an optical system, in particular, an optical system for diffusing and homogenizing a light beam emitted by a light source using a microlens array element, to ensure that there are no dark zones on the receiving surface of a detection array element, and to achieve efficient matching of a receiving module with an emitting module. The concept of embodiments of the present disclosure also lies in that the light source is diverged or collimated or defocused to achieve homogenization and diffusion of the emitted light beam, and specific parameters are set to eliminate diffraction, compensate for dark zones, to achieve dark zone-free illumination of to-be-detected areas, so as to avoid missing of scanning signals, to improve a matching efficiency between the receiving terminal and the emitting terminal, with the aim of solving the above technical problems in existing technology.

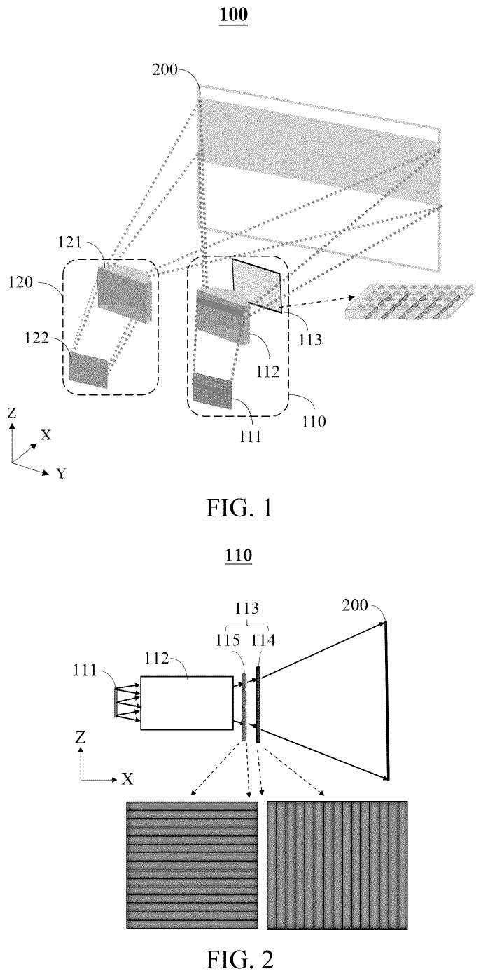

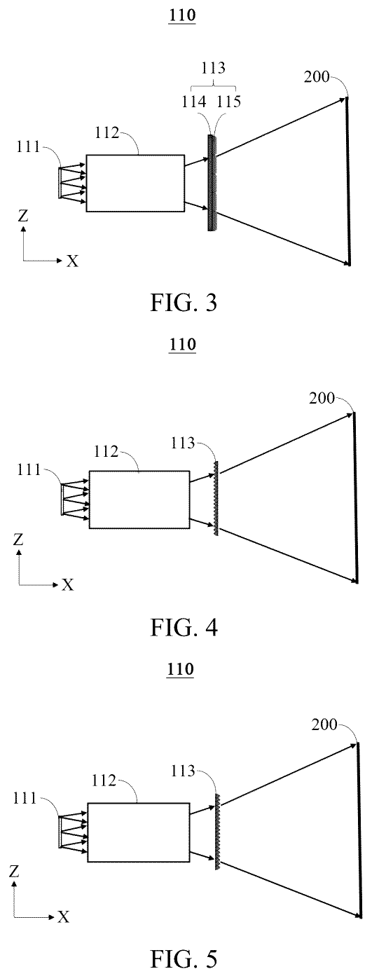

FIG. 1 schematically illustrates a schematic structure diagram of an optical system 100 according to example embodiments of the present disclosure. FIG. 2, FIG. 3, FIG. 4, and FIG. 5 respectively and schematically illustrate schematic structure diagrams of an emitting module 110 according to example embodiments of the present disclosure. The optical system 100 may be, for example, a lidar system, which is suitable for application scenarios such as autonomous driving, for example, suitable for application scenarios such as autonomous driving at the level of L2 as well as levels above L2. Autonomous driving at the L2 level refers to partially autonomous driving, where basic operations are done by the vehicle and a driver is responsible for monitoring the perimeter and taking over the vehicle at any time. It should be understood that the optical system 100 may also be used in other types of application scenarios such as roadblock detection, mapping, navigation, machine vision, mobile electronic devices, or projection.

As shown in FIG. 1 to FIG. 5, the optical system 100 may include the emitting module 110 and a receiving module 120. The emitting module 110 may include a light source 111 and a microlens array element 113 arranged in sequence along an optical axis from a first side to a second side, the microlens array element 113 homogenizes and diffuses a light beam emitted by the light source 111 in a first direction and/or a second direction to form a homogeneous light beam, where the first direction and the second direction are perpendicular to each other and are both perpendicular to the optical axis. The receiving module 120 may include a detection array element 122, the detection array element 122 is configured for receiving reflected light of the homogeneous light beam. The optical axis herein extends in a direction where an X-axis is located, the first direction refers to a direction of the Y-axis, and the second direction refers to a direction of the Z-axis. In an alternative implementation, the Y-axis may extend along a horizontal direction and the Z-axis may extend along a vertical direction. Of course, in other alternative implementations, the directions of the Y-axis and the Z-axis may extend in other mutually perpendicular directions, respectively. The diffusion herein refers to diffusing the light beam.

An exemplary description of an operating process of the optical system 100 in terms of detection process of a to-be-detected detection object 200 is as follows.

The light source 111 of the emitting module 110 emits a light beam, which is diffused and homogenized by the microlens array element 113 to form a homogeneous light beam. The homogeneous light beam is incident on the to-be-detected detection object 200 and reflected by the to-be-detected detection object 200 to form Reflected light of the homogeneous light beam. The Reflected light of the homogeneous light beam is received by the detection array element 122 of the receiving module 120, and the detection array element 122 compares the received reflected light with the light beam emitted by the light source 111, after appropriate processing, may acquire relevant information such as a distance, orientation, height, speed, or posture, of the to-be-detected detection object 200, so as to realize detection, tracking, and recognition of the to-be-detected detection object 200.

The optical system 100 provided in embodiments/implementations of the present disclosure makes use of the microlens array element 113 to diffuse and homogenize the light beam emitted by the light source 111 in the first direction and/or the second direction, and makes the light beam emitted by the light source 111 become a homogeneous light beam, and the homogeneous light beam can form a light spot of a flood line, thus ensuring that there are no dark zones on a receiving surface of the detection array element 122, and achieving efficient matching of the receiving module 120 with the emitting module 110, improving the detection efficiency of the optical system 100.

In the example implementations, as shown in FIG. 1 to FIG. 5, the emitting module 110 may further include an emitting optical element 112 disposed between the light source 111 and the microlens array element 113. The emitting optical element 112 may diffuse and collimate the light beam emitted by the light source 111. The use of the emitting optical element 112 may enable the light beam emitted by the light source 111 to become a collimated light beam having a preset divergence angle, so as to cooperate with the microlens array element 113 to achieve efficient matching of the receiving module 120 with the emitting module 110. The use of the above microlens array element 113 may reduce a size of the light source 111, thus reducing a size of the emitting optical element 112, and reducing the cost of the optical system 100.

In the example implementations, as shown in FIG. 1, the receiving module 120 may further include a receiving optical element 121. The receiving optical element 121 converges the reflected light of the homogeneous beam, and the converged reflected light is received by the detection array element 122.

In the example implementations, a ratio of an area of the receiving surface of the detection array element 122 to a light-emitting area of the light source 111 may be n×m, where, n≥1, m≥1. FIG. 10A and FIG. 10B schematically illustrate, respectively, schematic diagrams of a light source and a light illuminated area of a detection array element according to example implementations of the present disclosure. The light source 111 may include a plurality of sub-light sources arranged in an array, the light from any one row of sub-light sources in the reflected light covers n rows of detection units in the detection array element 122 (FIG. 10A), and the light from any one column of sub-light sources in the reflected light covers m columns of detection units in the detection array element 122 (FIG. 10B). In other words, the light beam emitted by each row of the sub-light sources may illuminate n rows of detection units after being diffused and homogenized by the microlens array element 113, and the light beam emitted by each column of the sub-light sources may illuminate m columns of detection units after being diffused and homogenized by the microlens array element 113. It should be understood that a direction of the rows extends along the direction indicated by the first direction and a direction of the columns extends along the direction indicated by the second direction in implementations of the present disclosure.

As an example, the light source 111 may, for example, include a vertical cavity surface emitting laser (VCSEL). The light source 111 may, for example, have M×N sub-light sources, where M indicates the number of rows of sub-light sources in the light source 111, and N indicates the number of columns of sub-light sources in the light source 111.

As an example, the detection array element 122 may, for example, include a single-photon avalanche diode (SPAD) array element. The detection array element 122 may, for example, have nM×mN detection units, where nM indicates the number of rows of detection units in the detection array element 122, and mN indicates the number of columns of detection units in the detection array element 122. In the present implementation, the detection units are single-photon avalanche diodes.

The use of the above microlens array element 113 may compensate for dark zones in the detection array element 122 caused by pixel defects in the light source 111, ensure that there are no dark zones between the rows and between the columns in the detection array element 122, thereby realizing that there are no dark zones on the entire receiving surface of the detection array element 122. At the same time, the use of the microlens array element 113 may also reduce the size of the light source 111, simplify the drive circuit corresponding to the light source 111, thereby reducing the cost of the optical system 100.

It should be understood that, without departing from the teachings of the present disclosure, the light source 111 may also use other types of light sources, and the detection array element 122 may also use other types of detection elements, which is not limited in the present disclosure.

In example implementations, diffusion angles of the homogeneous light beam in the first direction and the second direction are the same. In other words, the number of rows n of detection units that can be illuminated by the light beam emitted by each row of sub-light sources after being diffused and homogenized by the microlens array element 113 is the same as the number of columns m of detection units that can be illuminated by the light beam emitted by each column of sub-light sources after being diffused and homogenized by the microlens array element 113. In an example, n=m=2.

In example implementations, diffusion angles of the homogeneous light beam in the first direction and the second direction are different. In other words, the number of rows n of detection units that can be illuminated by the light beam emitted by each row of sub-light sources after being diffused and homogenized by the microlens array element 113 is not the same as the number of columns m of detection units that can be illuminated by the light beam emitted by each column of sub-light sources after being diffused and homogenized by the microlens array element 113. In an example, n=1.5 and m=2; or, n=2 and m=1.5.

In example implementations, as shown in FIG. 2 and FIG. 3, the emitting module 110 may include two microlens array elements 113. The two microlens array elements 113 are a first microlens array element 114 and a second microlens array element 115, respectively. The first microlens array element 114 may diffuse and homogenize the light beam emitted by the light source 111 in the first direction, and the second microlens array element 115 may diffuse and homogenize the light beam emitted by the light source 111 in the second direction. In an example, the first microlens array element 114 and the second microlens array element 115 may be affixed together.

As an example, the first microlens array element 114 may be affixed to a side surface of the emitting optical element 112 away from the light source 111. By making the first microlens array element 114 be affixed to the emitting optical element 112, an overall length of the optical system 100 can be effectively controlled, which is conducive to miniaturization of the optical system 100.

In example implementations, as shown in FIG. 4 and FIG. 5, the emitting module 110 may include one microlens array element 113. The microlens array element 113 may diffuse and homogenize the light beam emitted by the light source 111 in both the first direction and the second direction. As an example, the microlens array element 113 may be affixed to a side surface of the emitting optical element 112 away from the light source 111, or, the microlens array element 113 may be affixed to an optical window of the optical system, or, the microlens array element 113 may be integrally molded with the optical window of the optical system. By making the microlens array element 113 be affixed to the emitting optical element 112 or the optical window, the overall length of the optical system 100 can be effectively controlled, which is conducive to the miniaturization of the optical system 100.

In example implementations, the microlens array element 113 may include a plurality of microlenses arranged in an array. The optical system 100 may satisfy: 0<|R1|/|R2|≤10, where, R1 is a radius of curvature of a surface of a microlens perpendicular to the second direction, and R2 is a radius of curvature of a surface of the microlens perpendicular to the first direction. By constraining the ratio of the radius of curvature of the surface of the microlens perpendicular to the second direction to the radius of curvature of the surface of the microlens perpendicular to the first direction to a certain range, an ability of the microlens array element 113 to adjust the light beam can be better controlled, improving an imaging ability and a field-of-view of the optical system 100, while facilitating efficient matching of the receiving module 120 with the emitting module 110.

In example implementations, the optical system 100 may satisfy: 0<|F1/F21≤5, where, F1 is an effective focal length of the microlens in the first direction, and F2 is an effective focal length of the microlens in the second direction. By constraining the ratio of the effective focal length of the microlens in the first direction to the effective focal length of the microlens in the second direction to a certain range, the ability of the microlens array element 113 to adjust the light beam can be better controlled, enhancing a diffusion effect as well as a light-homogenizing effect of the microlens array element 113 on the light beam.

In example implementations, the optical system 100 may satisfy: 2≤|R1/D1|≤100, where, R1 is the radius of curvature of the surface of a microlens perpendicular to the second direction, and D1 is an effective diameter of the microlens in the first direction. As an example, 5≤|R1/D1|≤50. By constraining the ratio of the radius of curvature of the surface of the microlens perpendicular to the second direction to the effective diameter of the microlens in the first direction to a certain range, it is conducive to enhancing the diffusion effect as well as the light-homogenizing effect of the microlens array element 113 on the light beam.

In example implementations, the optical system 100 may satisfy: 2≤|R2/D2|≤70, where, R2 is the radius of curvature of a surface of a microlens perpendicular to the first direction, and D2 is an effective diameter of the microlens in the second direction. As an example, 5≤|R2/D2|≤30. By constraining the ratio of the radius of curvature of the surface of the microlens perpendicular to the first direction to the effective diameter of the microlens along the second direction to a certain range, it is conducive to enhancing the diffusion effect as well as the light-homogenizing effect of the microlens array element 113 on the light beam.

In example implementations, the optical system 100 may satisfy: dₘₐₓ/dₘᵢₙ≤2, where, dₘₐₓ is a maximum value in the thicknesses of the microlenses, and dₘᵢₙ is a minimum value in the thicknesses of the microlenses. As an example, 1≤dₘₐₓ/dₘᵢₙ≤1.5. By randomizing the thicknesses of the microlenses in the microlens array element 113, and making the ratio of the maximum value in the thicknesses of the microlenses to the minimum value in the thicknesses of the microlenses to be less than or equal to 2a, the diffraction effect can be substantially suppressed.

In example implementations, the optical system 100 may satisfy: |R1ₘₐₓ|/|R1ₘᵢₙ|1≤0.5, where, R1ₘₐₓ is a maximum value of the radii of curvature of the surfaces of the microlenses perpendicular to the second direction, and R1 min is a minimum value the radii of curvature of the surfaces of the microlenses perpendicular to the second direction. As an example, 0.5≤|R1ₘₐₓ|/|R1ₘᵢₙ|≤1.5. By randomizing the radii of curvatures of the surfaces of the microlenses perpendicular to the second direction, and making the ratio of the maximum value in the radii of curvature to the minimum value in the radii of curvature is less than or equal to 1.5, the diffraction effect can be substantially suppressed.

In example implementations, the optical system 100 may satisfy: |R2ₘₐₓ|/|R2ₘᵢₙ|≤1.5, where, R2ₘₐₓ is a maximum value of the radii of curvature of the surfaces of the microlenses perpendicular to the first direction, and R2ₘᵢₙ is a minimum value of the radii of curvature of the surfaces of the microlenses perpendicular to the first direction. As an example, 0.5≤|R2ₘₐₓ|/|R2ₘᵢₙ|≤1.5. By randomizing the radii of curvature of the surfaces of the microlenses perpendicular to the first direction, and making the ratio of the maximum value in the radii of curvature to the minimum value in the radii of curvature is less than or equal to 1.5, the diffraction effect can be substantially suppressed.

In example implementations, central points of the microlenses in the microlens array element 113 are randomly arranged in the first direction, e.g., the central points of the microlenses are randomly distributed on a centerline of the microlens array element 113 or on two sides of the centerline, and a distance from the central point of a microlens to the centerline of the microlens array element 113 does not exceed one-sixth of the effective diameter of the microlens in the first direction. Similarly, central points of the microlenses in the microlens array element 113 are randomly arranged in the second direction, e.g., the central points of the microlenses are randomly distributed on a centerline of the microlens array element 113 or on two sides of the centerline, and a distance from the central point of a microlens to the centerline of the microlens array element 113 does not exceed one-sixth of the effective diameter of the microlens in the second direction. Diffraction can be effectively eliminated by randomizing design of the central points of the microlenses.

In example implementations, the optical system 100 may satisfy: HFOV/(|R1|/D1)≤30°, where, HFOV is a horizontal field-of-view of the emitting optical element 112, D1 is the effective diameter of a microlens in the first direction, and R1 is the radius of curvature of the surface of the microlens perpendicular to the second direction. As an example, HFOV/(|R1|/D1)≤12°. By controlling the above conditional equation, it can be ensured that the microlens array element 113 has a better diffusion effect as well as a better light-homogenizing effect on the light beam emitted by the light source 111 in the first direction.

In example implementations, the optical system 100 may satisfy: 0.5≤|Fθ_{TX}/Fθ_{RX}|≤1.5, where, Fθ_{TX} is a distortion of the emitting optical element 112, and Fθ_{RX} is a distortion of the receiving optical element 121. As an example, |Fθ_{TX}/Fθ_{RX}−1|≤0.1, that is, 0.9≤|Fθ_{TX}/Fθ_{RX}|≤1.1. The distortion Fθ_{TX} of the emitting optical element 112 may satisfy: Fθ_{TX}=((Y−Y₀)/Y₀)×100%, where, Y represents an actual image height of the emitting optical element 112, and Y₀ represents an ideal image height of the emitting optical element 112. The distortion Fθ_{RX} of the receiving optical element 121 may satisfy: Fθ_{RX}=((Y′−Y₀′)/Y₀′)×100%, where, Y′ represents an actual image height of the receiving optical element 121, and Y₀′ represents an ideal image height of the receiving optical element 121. By constraining the ratio of the distortion of the emitting optical element 112 to the distortion of the receiving optical element 121 to a certain range, it can achieve co-distortion of the receiving optical element 121 and the emitting optical element 112, thus ensuring that the receiving module 120 matches the emitting module 110, and improving the detection efficiency of the optical system 100.

In example implementations, the optical system 100 may satisfy: 0<L2/L1≤3, where, L1 is a distance from the light source 111 to a second side surface of the microlens array element 113, and L2 is a distance from a receiving surface of the receiving optical element 121 to the detection array element 122. As an example, 0.5<L2/L1≤2. By controlling the above conditional equation, it can constrain total track lengths of the emitting module 110 and the receiving module 120, improve the matching efficiency between the receiving module 120 and the emitting module 110, and avoid the problem of mismatch between the receiving module 120 and the emitting module 110 caused by a large difference between the total track length of the receiving module 120 and the total track length of the emitting module 110, for example, avoiding problems such as large field-of-view of the emitting module 110, light blocking caused by the total track length of the receiving module 120 being excessive, at the same time, it is conducive to the miniaturization of the optical system 100, and reducing the cost of the optical system 100.

In the example implementations, the light source 111 is configured as a plurality of light-emitting channels in the second direction or the first direction, when the light source 111 is configured as a plurality of light-emitting channels in the second direction, each light-emitting channel includes i rows of sub-light sources in the second direction, and when the light source 111 is configured as a plurality of light-emitting channels in the first direction, each light-emitting channel includes i columns of sub-light sources in the first direction.

In addition, the optical system 100 may satisfy: 1≤α2/α1≤F_{T}×2×tan(HFOV/2)/(C/i)/Le, where, α1 is a collimation degree of the sub-light source before passing through the microlens array element 113, α2 is a collimation degree of the sub-light source after passing through the microlens array element 113, F_{T} is a focal length of the emitting optical element 112, HFOV is the horizontal field-of-view of the emitting optical element 112, C is the number of the sub-light sources contained in a light-emitting channel, i is the number of rows of the sub-light sources contained in the light-emitting channel in the second direction or the number of columns of the sub-light sources contained in the light-emitting channel in the first direction, C/i is the number of light-emitting holes in a single row of channel in the first or second direction; Le is a maximum diameter of the sub-light source, where, 1≤F_{T}×2×tan(HFOV/2)/(C/i)/Le≤35. By controlling the above conditional equation, the sub-light sources in each light-emitting channel can be effectively utilized, ensuring that the microlens array element 113 has a better diffusion effect as well as a better light-homogenizing effect on the light beam emitted by the light source 111. As an example, F_{T}×tan(HFOV/2)/(C/i)/Le≤α2/α1≤F_{T}×2×tan(HFOV/2)/(C/i)/Le.

Detailed embodiments of the optical system 100 that may be applicable to the above implementations are further described below.

### Embodiment 1

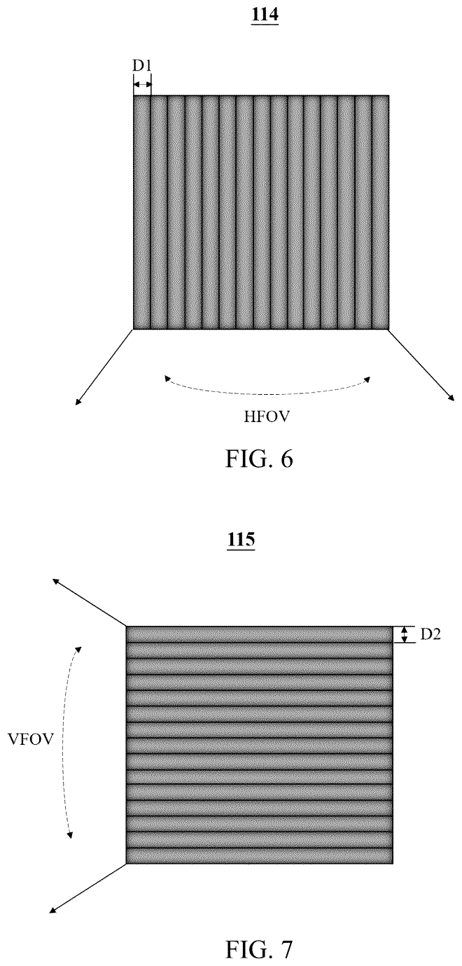

FIG. 2 schematically illustrate a schematic structure diagram of the emitting module 110 of Embodiment 1. FIG. 6 schematically illustrates a schematic structure diagram of the first microlens array element 114 of Embodiment 1. FIG. 7 schematically illustrates a schematic structure diagram of the second microlens array element 115 of Embodiment 1. As shown in FIGS. 1, 2, 6, and 7, the optical system 100 may include the emitting module 110 and the receiving module 120.

The emitting module 110 may include the light source 111, the emitting optical element 112, and two microlens array elements 113 arranged in sequence along an optical axis from a first side to a second side, the two microlens array elements 113 are independently disposed as the first microlens array element 114 and the second microlens array element 115, respectively, where the second microlens array element 115 is closer to the light source 111 than the first microlens array element 114. A light beam emitted by the light source 111 is first diffused and collimated by the emitting optical element 112 and then diffused and homogenized by the second microlens array element 115 and the first microlens array element 114 to form a homogeneous light beam. The first microlens array element 114 may diffuse and homogenize the light beam emitted by the light source 111 in the first direction, and the second microlens array element 115 may diffuse and homogenize the light beam emitted by the light source 111 in the second direction, where the first direction and the second direction are perpendicular to each other and are both perpendicular to the optical axis. Both the first microlens array element 114 and the second microlens array element 115 may include a plurality of microlenses arranged in an array.

The receiving module 120 may include the receiving optical element 121 and the detection array element 122. Reflected light of the homogeneous light beam is converged by the receiving optical element 121 and then received by the detection array element 122.

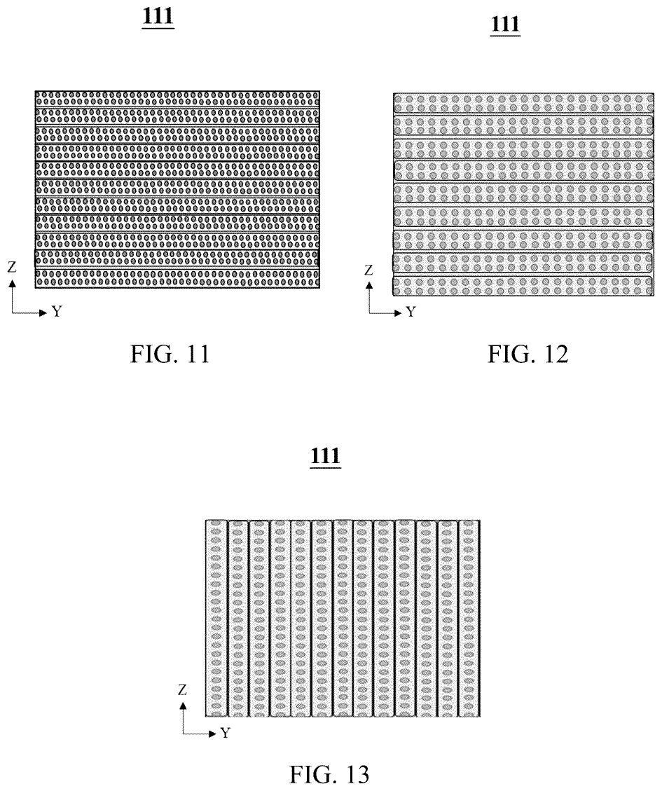

As an example, FIG. 11 schematically illustrates a schematic structure diagram of the light source 111, and black shaded holes in FIG. 11 denote light-emitting holes, i.e., one black shaded hole corresponds to one sub-light source. As shown in FIG. 11, the light source 111 is configured as a plurality of light-emitting channels in the second direction, which may be 32 light-emitting channels, and each light-emitting channel includes two rows of sub-light sources in the second direction, and the sub-light sources are distributed in a triangular shape. Each sub-light source is a circular hole, and each sub-light source has a maximum diameter of 30 m. The number C of the sub-light sources contained in each light-emitting channel is 120.

As an example, a ratio of the area of the receiving surface of the detection array element 122 to the light-emitting area of the light source 111 may be, for example, 3.

As an example, L1 is a distance from the light source 111 to a second side surface of the first microlens array element 114, L2 is a distance from the receiving surface of the receiving optical element 121 to the detection array element 122, and L1=L2, i.e., the total track length of the emitting module 110 and the total track length of the receiving module 120 are equal and both are 30 mm.

As an example, a radius of curvature of a surface of a microlens in the first microlens array element 114 perpendicular to the second direction is R1, and a radius of curvature of a surface of the microlens in the second microlens array element 115 perpendicular to the first direction is R2. In addition, |R1|/|R2|=0.824, where, |R1|=3.75 mm and |R2|=4.55 mm.

As an example, the detection array element 122 has an aspect ratio of 4:3.

As an example, a distortion Fθ_{TX} of the emitting optical element 112 and a distortion Fθ_{RX} of the receiving optical element 121 are the same, i.e., |Fθ_{TX}/Fθ_{RX}|=1.

As an example, the optical system 100 may satisfy: HFOV/(|R1|/D1)≤30°, where, HFOV is a horizontal field-of-view of the emitting optical element 112, R1 is the radius of curvature of the surface of the microlens in the first microlens array element 114 perpendicular to the second direction, D1 is an effective diameter of the microlens in the first microlens array element 114 in the first direction, where, 0.005 mm≤D1≤1 mm and 0.1 mm≤R1≤20 mm.

As an example, an effective focal length of the microlens in the first microlens array element 114 in the first direction is F1, and an effective focal length of the microlens in the second microlens array element 115 in the second direction is F2. In addition, |F1/F21=0.824, where, F1=7.23 mm and F2=−8.77 mm.

As an example, a collimation degree of the sub-light source before passing through the microlens array element 113 is α1, and a collimation degree of the sub-light source after passing through the microlens array element 113 is α2, and α2/α1=2. A focal length F_{T} of the emitting optical element 112 is 2 mm, the horizontal field-of-view HFOV of the emitting optical element 112 is 128°, and F_{T}×2×tan(HFOV/2)/(C/i)/Le=4.556.

As an example, the optical system 100 has an overall divergence angle of 128°×96°. The matching efficiency between the receiving module 120 and the emitting module 110 is up to 98%.

### Embodiment 2

FIG. 3 schematically illustrate a schematic structure diagram of the emitting module 110 of Embodiment 2. As shown in FIG. 1 and FIG. 3, the optical system 100 may include the emitting module 110 and the receiving module 120.

The emitting module 110 may include the light source 111, the emitting optical element 112, and two microlens array elements 113 arranged in sequence along an optical axis from a first side to a second side, the two microlens array elements 113 are the first microlens array element 114 and the second microlens array element 115, respectively, where the first microlens array element 114 is closer to the light source 111 than the second microlens array element 115, and the first microlens array element 114 is affixed to the second microlens array element 115. A light beam emitted by the light source 111 is first diffused and collimated by the emitting optical element 112 and then diffused and homogenized by the first microlens array element 114 and the second microlens array element 115 to form a homogeneous light beam. The first microlens array element 114 may diffuse and homogenize the light beam emitted by the light source 111 in the first direction, and the second microlens array element 115 may diffuse and homogenize the light beam emitted by the light source 111 in the second direction, where the first direction and the second direction are perpendicular to each other and are both perpendicular to the optical axis. Both the first microlens array element 114 and the second microlens array element 115 may include a plurality of microlenses arranged in an array.

The receiving module 120 may include the receiving optical element 121 and the detection array element 122. Reflected light of the homogeneous beam is converged by the receiving optical element 121 and then received by the detection array element 122.

As an example, the light source 111 is configured as a plurality of light-emitting channels in the second direction, which may be 32 light-emitting channels, and each light-emitting channel includes three rows of sub-light sources in the second direction, and the sub-light sources are distributed in a triangular shape or a rectangular shape. Each sub-light source is a circular hole, and each sub-light source has a maximum diameter of 26 μm. The number C of the sub-light sources contained in each light-emitting channel is 156.

As an example, a ratio of the area of the receiving surface of the detection array element 122 to the light-emitting area of the light source 111 may be, for example, 3.

As an example, L1 is a distance from the light source 111 to a second side surface of the second microlens array element 115, L2 is a distance from the receiving surface of the receiving optical element 121 to the detection array element 122, and L1=L2, i.e., the total track length of the emitting module 110 and the total track length of the receiving module 120 are equal and both are 35 mm.

As an example, a radius of curvature of a surface of a microlens in the first microlens array element 114 perpendicular to the second direction is R1, and a radius of curvature of a surface of the microlens in the second microlens array element 115 perpendicular to the first direction is R2. In addition, |R1/|R2|=1, where, |R1|=3.35 mm and |R2|=3.35 mm.

As an example, the detection array element 122 has an aspect ratio of 5:4.

As an example, a distortion Fθ_{TX} of the emitting optical element 112 and a distortion Fθ_{RX} of the receiving optical element 121 are the same, i.e., |Fθ_{TX}/Fθ_{RX}|=1.

As an example, the optical system 100 may satisfy: HFOV/(|R1|/D1)≤30°, where, HFOV is a horizontal field-of-view of the emitting optical element 112, R1 is the radius of curvature of the surface of the microlens in the first microlens array element 114 perpendicular to the second direction, D1 is an effective diameter of the microlens in the first microlens array element 114 in the first direction, where, 0.005 mm≤D1≤1 mm and 0.1 mm≤R1≤20 mm.

As an example, an effective focal length of the microlens in the first microlens array element 114 in the first direction is F1, and an effective focal length of the microlens in the second microlens array element 115 in the second direction is F2. In addition, |F1/F21=1, where, F1=6.46 mm and F2=−6.46 mm.

As an example, a collimation degree of the sub-light source before passing through the microlens array element 113 is α1, and a collimation degree of the sub-light source after passing through the microlens array element 113 is α2, and α2/α1=4. A focal length F_{T} of the emitting optical element 112 is 2 mm, the horizontal field-of-view HFOV of the emitting optical element 112 is 128°, and F_{T}×2×tan(HFOV/2)/(C/i)/Le=6.066.

As an example, the optical system 100 has an overall divergence angle of 128°×96°. The matching efficiency between the receiving module 120 and the emitting module 110 is up to 98%.

### Embodiment 3

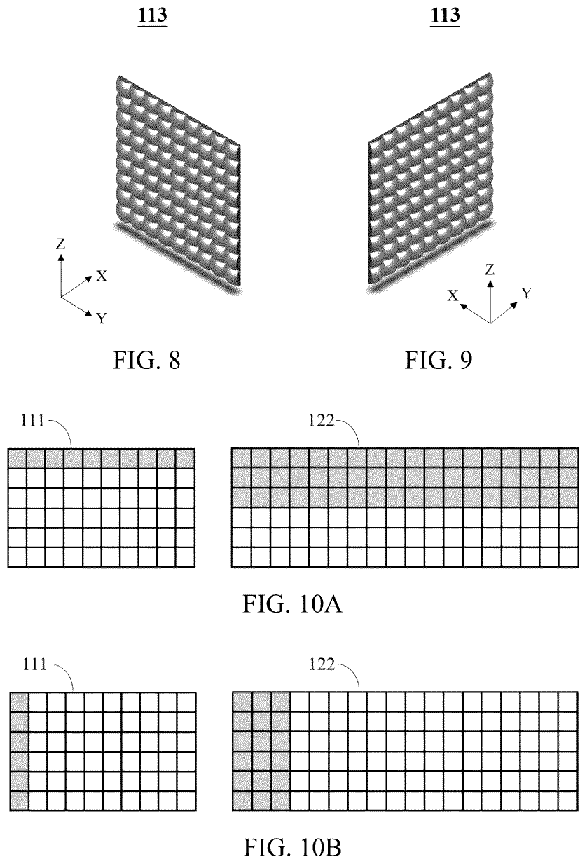

FIG. 4 schematically illustrate a schematic structure diagram of the emitting module 110 of Embodiment 3. FIG. 8 schematically illustrates a schematic structure diagram of the microlens array element 113 of Embodiment 3. As shown in FIG. 1, FIG. 4 and FIG. 8, the optical system 100 may include the emitting module 110 and the receiving module 120.

The emitting module 110 may include the light source 111, the emitting optical element 112, and one microlens array element 113 arranged in sequence along an optical axis from a first side to a second side. A light beam emitted by the light source 111 is first diffused and collimated by the emitting optical element 112 and then diffused and homogenized by the microlens array element 113 to form a homogeneous light beam. The microlens array element 113 may diffuse and homogenize the light beam emitted by the light source 111 simultaneously in the first direction and the second direction, where the first direction and the second direction are perpendicular to each other and are both perpendicular to the optical axis. The microlens array element 113 may include a plurality of microlenses arranged in an array. The microlens array element 113 may be affixed to a side surface of the emitting optical element 112 away from the light source 111, or may be affixed to an optical window, or integrally molded onto the optical window.

The receiving module 120 may include the receiving optical element 121 and the detection array element 122. Reflected light of the homogeneous beam is converged by the receiving optical element 121 and then received by the detection array element 122.

As an example, FIG. 12 schematically illustrates a schematic structure diagram of the light source 111, and black shaded holes in FIG. 12 are light-emitting holes, i.e., one black shaded hole corresponds to one sub-light source. As shown in FIG. 12, the light source 111 is configured as a plurality of light-emitting channels in the second direction, which may be 32 light-emitting channels, and each light-emitting channel includes two rows of sub-light sources in the second direction, and the sub-light sources are distributed in a rectangular shape. Each sub-light source is a circular hole, and each sub-light source has a maximum diameter of 33 μm. The number C of the sub-light sources contained in each light-emitting channel is 136.

As an example, a ratio of the area of the receiving surface of the detection array element 122 to the light-emitting area of the light source 111 may be, for example, 4.

As an example, a distance L1 from the light source 111 to a second side surface of the microlens array element 113 is not equal to a distance L2 from the receiving surface of the receiving optical element 121 to the detection array element 122, i.e., the total track length of the emitting module 110 and the total track length of the receiving module 120 are not equal, for example, L1=18 mm and L2=30 mm.

As an example, for each microlens in the microlens array element 113, a radius of curvature of a surface of each microlens perpendicular to the second direction is R1, and a radius of curvature of a surface of each microlens perpendicular to the first direction is R2. In addition, |R1|/|R2|=0.587, where, |R1|=1.75 mm and |R21=2.98 mm.

As an example, the detection array element 122 has an aspect ratio of 4:3.

As an example, a distortion Fθ_{TX} of the emitting optical element 112 and a distortion Fθ_{RX} of the receiving optical element 121 satisfy: |Fθ_{TX}/Fθ_{RX}|=1.1.

As an example, the optical system 100 may satisfy: HFOV/(|R1|/D1)≤30°, where, HFOV is a horizontal field-of-view of the emitting optical element 112, R1 is the radius of curvature of the surface of the microlens perpendicular to the second direction, D1 is an effective diameter of the microlens in the first direction, where, 0.005 mm≤D1≤1 mm.

As an example, an effective focal length of the microlens in the first direction is F1, and an effective focal length of the microlens in the second direction is F2. In addition, |F1/F2|=0.586, where, F1=3.37 mm and F2=5.75 mm.

As an example, a collimation degree of the sub-light source before passing through the microlens array element 113 is α1, and a collimation degree of the sub-light source after passing through the microlens array element 113 is α2, and α2/α1=3. A focal length F_{T} of the emitting optical element 112 is 2.8 mm, the horizontal field-of-view HFOV of the emitting optical element 112 is 128°, and F_{T}×2×tan(HFOV/2)/(C/i)/Le=5.117.

As an example, the optical system 100 has an overall divergence angle of 128°×96°. The matching efficiency between the receiving module 120 and the emitting module 110 is up to 94%.

### Embodiment 4

FIG. 5 schematically illustrate a schematic structure diagram of the emitting module 110 of Embodiment 4. FIG. 9 schematically illustrates a schematic structure diagram of the microlens array element 113 of Embodiment 4. As shown in FIG. 1, FIG. 5 and FIG. 9, the optical system 100 may include the emitting module 110 and the receiving module 120.

The emitting module 110 may include the light source 111, the emitting optical element 112, and one microlens array element 113 arranged in sequence along an optical axis from a first side to a second side. A light beam emitted by the light source 111 is first diffused and collimated by the emitting optical element 112 and then diffused and homogenized by the microlens array element 113 to form a homogeneous light beam. The microlens array element 113 may diffuse and homogenize the light beam emitted by the light source 111 simultaneously in the first direction and the second direction, where the first direction and the second direction are perpendicular to each other and are both perpendicular to the optical axis. The microlens array element 113 may include a plurality of microlenses arranged in an array. The microlens array element 113 may be affixed to a side surface of the emitting optical element 112 away from the light source 111, or may be affixed to an optical window, or integrally molded onto the optical window.

The receiving module 120 may include the receiving optical element 121 and the detection array element 122. Reflected light of the homogeneous beam is converged by the receiving optical element 121 and then received by the detection array element 122.

As an example, FIG. 13 schematically illustrates a schematic structure diagram of the light source 111, and black shaded holes in FIG. 13 are light-emitting holes, i.e., one black shaded hole corresponds to one sub-light source. As shown in FIG. 13, the light source 111 is configured as a plurality of light-emitting channels in the first direction, which may be 128 light-emitting channels, and each light-emitting channel includes one column of sub-light sources in the first direction. Each sub-light source is a circular hole, and each sub-light source has a maximum diameter of 32 μm. The number C of the sub-light sources contained in each light-emitting channel is 68.

As an example, a ratio of the area of the receiving surface of the detection array element 122 to the light-emitting area of the light source 111 may be, for example, 1.4.

As an example, a distance L1 from the light source 111 to a second side surface of the microlens array element 113 is not equal to a distance L2 from the receiving surface of the receiving optical element 121 to the detection array element 122, i.e., the total track length of the emitting module 110 and the total track length of the receiving module 120 are not equal, for example, L1=16 mm and L2=30 mm.

As an example, for each microlens in the microlens array element 113, a radius of curvature of a surface of the microlens perpendicular to the second direction is R1, and a radius of curvature of a surface of the microlens perpendicular to the first direction is R2. In addition, |R1|/|R2|=3.862, where, |R1|=12.55 mm and |R21=3.25 mm.

As an example, the detection array element 122 has an aspect ratio of 3:2.

As an example, a distortion Fθ_{TX} of the emitting optical element 112 and a distortion Fθ_{RX} of the receiving optical element 121 are the same, and |Fθ_{TX}/Fθ_{RX}|=1.

As an example, the optical system 100 may satisfy: HFOV/(|R1|/D1)≤30°, where, HFOV is a horizontal field-of-view of the emitting optical element 112, R1 is the radius of curvature of the surface of the microlens perpendicular to the second direction, D1 is an effective diameter of the microlens in the first direction, where, 0.005 mm≤D1≤1 mm and 0.1 mm≤R1≤20 mm.

As an example, an effective focal length of the microlens in the first direction is F1, and an effective focal length of the microlens in the second direction is F2. In addition, |F1/F2|=3.867, where, F1=−24.21 mm and F2=−6.26 mm.

As an example, a collimation degree of the sub-light source before passing through the microlens array element 113 is α1, and a collimation degree of the sub-light source after passing through the microlens array element 113 is α2, and α2/α1=2. A focal length F_{T} of the emitting optical element 112 is 2.8 mm, the horizontal field-of-view HFOV of the emitting optical element 112 is 96°, and F_{T}×2×tan(HFOV/2)/(C/i)/Le=2.858.

As an example, the optical system 100 has an overall divergence angle of 126°×96°. The matching efficiency between the receiving module 120 and the emitting module 110 is up to 97%.

Some implementations of the present disclosure provide a method for manufacturing an optical system. An optical system obtained according to the manufacturing method may be, for example, the optical system 100 provided in the above implementations. The manufacturing method may include the following steps.

S10, setting an emitting module, the emitting module including a light source and a microlens array element arranged in sequence along an optical axis from a first side to a second side.

As an example, the emitting module may further include an emitting optical element disposed between the light source and the microlens array element. The emitting optical element may diffuse and collimate a light beam emitted by the light source. The use of the emitting optical element may enable the light beam emitted by the light source to become a collimated beam having a preset divergence angle, so as to cooperate with the microlens array element to achieve efficient matching of the receiving module with the emitting module. The use of the above microlens array element may reduce a size of the light source, thus reducing a size of the emitting optical element, and reducing the cost of the optical system.

S20, setting a receiving module, the receiving module including a detection array element.

As an example, the receiving module may further include a receiving optical element. The receiving optical element converges reflected light of a homogeneous light beam, and the converged reflected light is received by the detection array element.

The manufacturing method further includes: diffusing and homogenizing a light beam emitted by the light source in a first direction and/or a second direction using the microlens array element to form a homogeneous light beam, where the first direction and the second direction are perpendicular to each other and are both perpendicular to the optical axis; and receiving reflected light of the homogeneous light beam using the detection array element.

In example implementations, the manufacturing method further includes: adjusting a structure of the microlens array element, such that a ratio of an area of a receiving surface of the detection array element to a light-emitting area of the light source may be n×m, where, n≥1, m≥1. The light source may include a plurality of sub-light sources arranged in an array, the light from any one row of sub-light sources in the reflected light covers n rows of detection units in the detection array element, and the light from any one column of sub-light sources in the reflected light covers m columns of detection units in the detection array element. In other words, the light beam emitted by each row of the sub-light sources may illuminate n rows of detection units after being diffused and homogenized by the microlens array element, and the light beam emitted by each column of the sub-light sources may illuminate m columns of detection units after being diffused and homogenized by the microlens array element. It should be understood that a direction of the rows extends along the direction indicated by the first direction and a direction of the columns extends along the direction indicated by the second direction in implementations of the present disclosure.

As an example, diffusion angles of the homogeneous light beam in the first direction and the second direction are the same. In other words, the number of rows n of detection units that can be illuminated by the light beam emitted by each row of sub-light sources after being diffused and homogenized by the microlens array element 113 is the same as the number of columns m of detection units that can be illuminated by the light beam emitted by each column of sub-light sources after being diffused and homogenized by the microlens array element 113. In an example, n=m=2.

As an example, diffusion angles of the homogeneous light beam in the first direction and the second direction are different. In other words, the number of rows n of detection units that can be illuminated by the light beam emitted by each row of sub-light sources after being diffused and homogenized by the microlens array element 113 is not the same as the number of columns m of detection units that can be illuminated by the beam emitted by each column of sub-light sources after being diffused and homogenized by the microlens array element 113. In an example, n=1.5 and m=2; or, n=2 and m=1.5.

The use of the above microlens array element may compensate for dark zones in the detection array element caused by pixel defects in the light source, ensure that there are no dark zones between the rows and between the columns in the detection array element, thereby realizing that there are no dark zones on the entire receiving surface of the detection array element. At the same time, the use of the microlens array element may also reduce the size of the light source, simplify a drive circuit corresponding to the light source, thereby reducing the cost of the optical system.

In example implementations, the manufacturing method further includes: adjusting a structure of the emitting module, such that the emitting module includes one microlens array element, and the microlens array element diffuses and homogenizes the light beam in both the first direction and the second direction. As an example, the microlens array element may be affixed to a side surface of the emitting optical element away from the light source, or, the microlens array element is affixed to an optical window of the optical system, or, the microlens array element is integrally molded with the optical window of the optical system. By making the microlens array element be affixed to the emitting optical element or the optical window, an overall length of the optical system can be effectively controlled, which is conducive to miniaturization of the optical system.

In example implementations, the manufacturing method further includes: adjusting a structure of the emitting module, such that the emitting module includes two microlens array elements, a first microlens array element and a second microlens array element, respectively, where, the first microlens array element diffuses and homogenizes the light beam in the first direction, and the second microlens array element diffuses and homogenizes the light beam in the second direction. In an example, the first microlens array element and the second microlens array element may be affixed together.

In example implementations, the manufacturing method further includes: adjusting a structure of a microlens of the microlens array element, such that the optical system may satisfy: 0<|R1|/|R2|≤10, where, R1 is a radius of curvature of a surface of a microlens perpendicular to the second direction, and R2 is a radius of curvature of a surface of the microlens perpendicular to the first direction. By constraining the ratio of the radius of curvature of the surface of the microlens perpendicular to the second direction to the radius of curvature of the surface of the microlens perpendicular to the first direction to a certain range, an ability of the microlens array element to adjust the light beam can be better controlled, improving an imaging ability and a field-of-view of the optical system, while facilitating efficient matching of the receiving module with the emitting module.

In example implementations, the manufacturing method further includes: adjusting a structure of a microlens of the microlens array element, such that the optical system may satisfy: 0<|F1/F2|≤5, where, F1 is an effective focal length of a microlens in the first direction, and F2 is an effective focal length of the microlens in the second direction. By constraining the ratio of the effective focal length of the microlens in the first direction to the effective focal length of the microlens in the second direction to a certain range, the ability of the microlens array element to adjust the light beam can be better controlled, enhancing a diffusion effect as well as a light-homogenizing effect of the microlens array element on the light beam.

In example implementations, the manufacturing method further includes: adjusting a structure of a microlens of the microlens array element, such that the optical system may satisfy: 2≤|R1/D1|≤100, where, R1 is the radius of curvature of a surface of a microlens perpendicular to the second direction, and D1 is an effective diameter of the microlens in the first direction. As an example, 5≤|R1/D1|≤50. By constraining the ratio of the radius of curvature of the surface of the microlens perpendicular to the second direction to the effective diameter of the microlens in the first direction to a certain range, it is conducive to enhancing the diffusion effect as well as the light-homogenizing effect of the microlens array element on the light beam.

In example implementations, the manufacturing method further includes: adjusting a structure of a microlens of the microlens array element, such that the optical system may satisfy: 2≤|R2/D2|≤70, where, R2 is the radius of curvature of the surface of a microlens perpendicular to the first direction, and D2 is an effective diameter of the microlens in the second direction. As an example, 5≤|R2/D2|≤30. By constraining the ratio of the radius of curvature of the surface of the microlens perpendicular to the first direction to the effective diameter of the microlens along the second direction to a certain range, it is conducive to enhancing the diffusion effect as well as the light-homogenizing effect of the microlens array element on the light beam.

In example implementations, the manufacturing method further includes: adjusting a structure of a microlens of the microlens array element, such that the optical system may satisfy: dₘₐₓ/dₘᵢₙ≤², where, dₘₐₓ is a maximum value of thicknesses of the microlenses, and dₘᵢₙ is a minimum value of the thicknesses of the microlenses. As an example, 1≤dₘₐₓ/dₘᵢₙ≤1.5. By randomizing the thicknesses of the microlenses in the microlens array element 113, and making the ratio of the maximum value in the thicknesses of the microlenses to the minimum value in the thicknesses of the microlenses to be less than or equal to 2a, the diffraction effect can be substantially suppressed.

In example implementations, the manufacturing method further includes: adjusting a structure of a microlens of the microlens array element, such that the optical system may satisfy: |R1ₘₐₓ|/|R1ₘᵢₙ|≤1.5, where, R1ₘₐₓ is a maximum value of the radii of curvature of the surfaces of the microlenses perpendicular to the second direction, and R1ₘᵢₙ is a minimum value of the radii of curvature of the surfaces in the microlenses perpendicular to the second direction. As an example, 0.5≤|R1ₘₐₓ|/|R1ₘᵢₙ|≤1.5. By randomizing the radii of curvatures of the surfaces of the microlenses perpendicular to the second direction, and making the ratio of the maximum value in the radii of curvature to the minimum value in the radii of curvature is less than or equal to 1.5, the diffraction effect can be substantially suppressed.

In example implementations, the manufacturing method further includes: adjusting a structure of a microlens of the microlens array element, such that the optical system may satisfy: |R2ₘₐₓ∈/|R2ₘᵢₙ|≤1.5, where, R2ₘₐₓ is a maximum value of the radii of curvature of the surfaces of the microlenses perpendicular to the first direction, and R2ₘᵢₙ is a minimum value of the radii of curvature of the surfaces of the microlenses perpendicular to the first direction. As an example, 0.5≤|R2ₘₐₓ|/|R2ₘᵢₙ|≤1.5. By randomizing the radii of curvature of the surfaces of the microlenses perpendicular to the first direction, and making the ratio of the maximum value in the radii of curvature to the minimum value in the radii of curvature is less than or equal to 1.5, the diffraction effect can be substantially suppressed.

In example implementations, the manufacturing method further includes: adjusting a structure of a microlens of the microlens array element, such that central points of the microlenses in the microlens array element are randomly arranged in the first direction, e.g., the central points of the microlenses are randomly distributed on a centerline of the microlens array element or on two sides of the centerline, and a distance from the central point of a microlens to the centerline of the microlens array element does not exceed one-sixth of the effective diameter of the microlens in the first direction. Similarly, adjusting a structure of a microlens of the microlens array element, such that central points of the microlenses in the microlens array element are randomly arranged in the second direction, e.g., the central points of the microlenses are randomly distributed on a centerline of the microlens array element or on two sides of the centerline, and a distance from the central point of a microlens to the centerline of the microlens array element does not exceed one-sixth of the effective diameter of the microlens in the second direction. Diffraction can be effectively eliminated by randomizing design of the central points of the microlenses.

In example implementations, the manufacturing method includes: adjusting a structure of the emitting optical element and a microlens of the microlens array element, such that the optical system satisfies: HFOV/(|R1|/D1)≤30°, where, HFOV is a horizontal field-of-view of the emitting optical element, D1 is the effective diameter of a microlens in the first direction, and R1 is the radius of curvature of the surface of the microlens perpendicular to the second direction. As an example, HFOV/(|R1|/D1)≤12°. By controlling the above conditional equation, it can be ensured that the microlens array element has a better diffusion effect as well as a better light-homogenizing effect on the light beam emitted by the light source in the first direction.

In example implementations, the manufacturing method includes: adjusting a structure of the emitting optical element and the receiving optical element, such that the optical system may satisfy: 0.5≤|Fθ_{TX}/Fθ_{RX}|≤1.5, where, Fθ_{TX} is a distortion of the emitting optical element, and Fθ_{RX} is a distortion of the receiving optical element. As an example, |Fθ_{TX}/Fθ_{RX}−1|≤0.1, that is, 0.9≤|Fθ_{TX}/Fθ_{RX}|≤1.1. The distortion Fθ_{TX} of the emitting optical element may satisfy: Fθ_{TX}=((Y−Y₀)/Y₀)×100%, where, Y represents an actual image height of the emitting optical element, and Y₀ represents an ideal image height of the emitting optical element. The distortion Fθ_{RX} of the receiving optical element may satisfy: Fθ_{RX}=((Y′−Y₀′)/Y₀′)×100%, where, Y′ represents an actual image height of the receiving optical element, and Y₀′ represents an ideal image height of the receiving optical element. By constraining the ratio of the distortion of the emitting optical element to the distortion of the receiving optical element to a certain range, it can achieve co-distortion of the receiving optical element and the emitting optical element, thus ensuring that the receiving module matches the emitting module, and improving a detection efficiency of the optical system.

In example implementations, the manufacturing method includes: adjusting a position of the light source and the receiving optical element, such that the optical system may satisfy: 0<L2/L1≤3, where, L1 is a distance from the light source to a second side surface of the microlens array element, and L2 is a distance from a receiving surface of the receiving optical element to the detection array element. As an example, 0.5<L2/L1≤2. By controlling the above conditional equation, it can constrain total track lengths of the emitting module and the receiving module, improve a matching efficiency between the receiving module and the emitting module, and avoid the problem of mismatch between the receiving module and the emitting module caused by a large difference between the total track length of the receiving module and the total track length of the emitting module, for example, avoiding problems such as large field-of-view of the emitting module, light blocking caused by the total track length of the receiving module being excessive, at the same time, it is conducive to the miniaturization of the optical system, and reducing the cost of the optical system.

In example implementations, the manufacturing method includes: setting an emitting optical element between the light source and the microlens array element, where, the light source includes a plurality of sub-light sources arranged in an array, and the light source is configured as a plurality of light-emitting channels in the second direction or the first direction, such that the optical system satisfies: 1≤α2/α1≤F_{T}×2×tan(HFOV/2)/(C/i)/Le, where, α1 is a collimation degree of the sub-light source before passing through the microlens array element, α2 is a collimation degree of the sub-light source after passing through the microlens array element, F_{T} is a focal length of the emitting optical element, HFOV is the horizontal field-of-view of the emitting optical element, C is the number of the sub-light sources contained in a light-emitting channel, i is the number of rows of the sub-light sources contained in the light-emitting channel in the second direction or the number of columns of the sub-light sources contained in the light-emitting channel in the first direction; Le is a maximum diameter of the sub-light source, where, 1≤F_{T}×2×tan(HFOV/2)/(C/i)/Le≤35. By controlling the above conditional equation, the sub-light sources in each light-emitting channel can be effectively utilized, ensuring that the microlens array element has a better diffusion effect as well as a better light-homogenizing effect on the light beam emitted by the light source. As an example, F_{T}×tan(HFOV/2)/(C/i)/Le≤α2/α1≤F_{T}×2×tan(HFOV/2)/(C/i)/Le.

Other embodiments of the present disclosure also propose an emitting terminal and a lidar system. Detailed application scenarios of the emitting terminal and the lidar system are as follows.

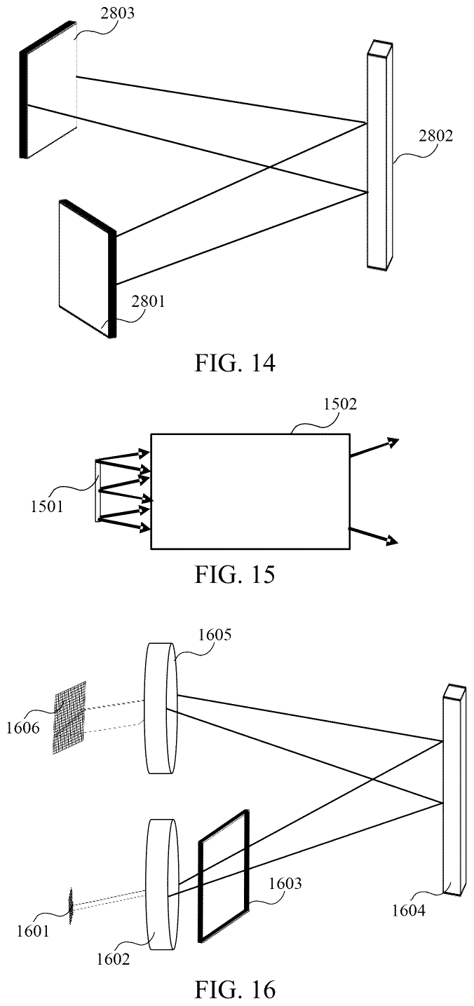

FIG. 14 shows a schematic diagram of an application scenario of an emitting terminal provided by embodiments of the present disclosure. As shown in FIG. 14, an emitting terminal 1401 emits a light beam to irradiate to a target object 1402, and reflected light beam of the target object 1402 is captured by a receiving terminal 1403 to form a light signal associated with the target object 1402, so as to infer the target object 1402 inversely based on the light signal, thereby realizing a scanning function of a scanning detection device, such as a lidar.

FIG. 15 shows a schematic structure diagram I of an emitting terminal provided by embodiments of the present disclosure. As shown in FIG. 15, the emitting terminal includes: a light source 1501, configured to emit a row and/or column of light beam for detecting a target object; and a light source processing element 1502, configured to process the row and/or column of light beam emitted by the light source to obtain a diffused row and/or column of light beam.

In particular, row of light beam, or column of light beam, or row and column of light beam may be emitted by the light source to provide a line light source for flood-line scanning, where the row of light beam or column of light beam are single row of light beam or single column of light beam, and the row and column of light beam include multiple rows or multiple columns of light beam.

In a feasible implementation, the light source processing element includes an emitting terminal lens assembly (the “emitting optical element” described in the above implementations and embodiments will be directly expressed as “emitting terminal lens assembly” in the current and following implementations and embodiments) and a microlens array; where, the emitting terminal lens assembly is configured to diverge or collimate the row and/or column of light beam emitted by the light source; and the microlens array is configured to homogenize and diffuse the diverged or collimated light beam to obtain a diffused row and/or column of light beam.

In another feasible implementation, the light source processing element includes a microlens array; where, the microlens array is configured to diverge the row and/or column of light beam emitted by the light source to obtain a diffused row and/or column of light beam.

In a feasible implementation, the microlens array may be obtained by arranging a plurality of microlens units on a substrate in an array, which may include a transverse array, or a longitudinal array, or a transverse and longitudinal bidirectional array. The microlens units in the transverse array are mainly used for homogenizing and diffusing the light beam in a horizontal direction, the microlens units in the longitudinal array are mainly used for homogenizing and diffusing the light beam in a vertical direction, and the microlens units in the transverse and longitudinal bidirectional array may homogenize and diffuse the microlens units in both the horizontal direction and the vertical direction at the same time. Each microlens unit needs to satisfy a homogenization design condition in order to achieve beam homogenization and diffusion in the horizontal and/or vertical directions, i.e., a horizontal radius of curvature R1 and a horizontal diameter D1 of each microlens unit satisfy: 2≤|R1/D1|≤100; preferably, 5≤|R1/D1|≤50; and/or a vertical radius of curvature R2 and a vertical diameter D2 of each microlens unit satisfy: 2≤|R2/D2|≤70; preferably, 5≤|R2/D2|≤30.

In a feasible implementation, since the row and/or column of light beam is a strip beam, a light wave physical property of the strip beam is that it is prone to diffraction, in order to eliminate diffraction and avoid strong diffraction interference brought about by regularized arrays, it may disrupt the regular arrangement of the microlens array when processing the light beam, therefore, the array arrangement is retained in order to retain the homogenizing and diffusion function of the microlens array itself, and characteristics such as the shape, or central point, of an individual microlens unit within the microlens array are changed within a certain range to achieve a diffraction suppression effect.

In a feasible implementation, thicknesses of the microlens units are thickness random values, and a magnitude of variation d0 of a thickness random value and a preset thickness d satisfy: d0≤⅓*d; preferably, d0≤⅕*d.

In a feasible implementation, the horizontal radii of curvature of the microlens units are horizontal radius of curvature random values, and a maximum horizontal radius of curvature random value R1max and a minimum horizontal radius of curvature random value R1 min in the horizontal radius of curvature random values satisfy: |R1max/R1 min|≤1.5; preferably, 0.5≤|R1max/R1 min|≤1.5; the vertical radii of curvature of the microlens units are vertical radius of curvature random values, and a maximum vertical radius of curvature random value R2max and a minimum vertical radius of curvature random value R2 min in the vertical radius of curvature random values satisfy: |R2max/R2 min|≤1.5; preferably, 0.5≤|R2max/R2 min|≤1.5.

In a feasible implementation, central points of horizontal diameters and/or vertical diameters of the plurality of microlens units are not in the same plane; a height difference D3 between a central point of a horizontal diameter and a central point of a preset microlens unit diameter and a preset microlens unit diameter D4 in the horizontal direction satisfy: |D3|≤⅓*D4; and/or a height difference D5 between the central point of a vertical diameter and the preset microlens unit diameter and the preset microlens unit diameter D6 in the vertical direction satisfy: |D5|≤⅓*D6.

For the light source processing element containing the emitting terminal lens assembly, in order to improve a light-homogenizing and diffusion effect, the emitting terminal lens assembly thereof may also satisfy the following relationship: a horizontal field-of-view HFOV of the emitting terminal lens assembly, the horizontal radius of curvature R1 and the horizontal diameter D1 of the microlens unit satisfy the following diffusion relationship: HFOV/(R1/D1)≤30; preferably, HFOV/(R1/D1)≤12.

In a feasible implementation, a pre-homogenization collimation degree α1 and a post-homogenization collimation degree α2 of the light source, the horizontal field-of-view HFOV of the emitting terminal lens assembly, a focal length F_{T} of the emitting terminal lens assembly, the number of light-emitting holes C in a single row of channel in the horizontal direction (the “number of light-emitting holes C in a single row of channel” described in the current implementation and following implementations have the same meaning as the “C/i” mentioned in the above implementations), and a diameter Le of a single light-emitting hole of the light source satisfy the following irradiation area relationship: 1≤α2/α1≤F_{T}*2 tan(HFOV/2)/C/Le; where, α1>0, 1≤F_{T}*2 tan(HFOV/2)/C/Le≤35; preferably, F_{T}*tan(HFOV/2)/C/Le≤α2/α1≤F_{T}*2 tan(HFOV/2)/C/Le.

In yet another feasible implementation, the light source processing element includes an emitting terminal lens assembly; where, the emitting terminal lens assembly is configured to homogenize and diffuse the row and/or column of light beam emitted by the light source whose spacing to the emitting terminal lens assembly has been adjusted, to obtain a diffused row and/or column of light beam.

For the light source processing element containing only the emitting terminal lens assembly, adjustment of the light source spacing between the light source and the emitting terminal lens assembly is realized by adjusting the position of the light source, to achieve a light-homogenizing and diffusion effect by means of defocusing.

In a feasible implementation, a collimation degree α3 before adjusting the spacing between the light source and the emitting terminal lens assembly, a collimation degree α4 after adjusting the spacing between the light source and the emitting terminal lens assembly, the horizontal field-of-view HFOV of the emitting terminal lens assembly, the focal length F_{T} of the emitting terminal lens assembly, and a defocus range d of the light source satisfy the following irradiation area relationship: F_{T}*tan(HFOV/2)*d≤α4/α3≤F_{T}*tan(HFOV/2)/d; where, the collimation degree α3 before adjusting the spacing between the light source and the emitting terminal lens assembly and the collimation degree α4 after adjusting the spacing between the light source and the emitting terminal lens assembly satisfy the following relationship: 1≤α4/α3≤120; preferably, 1≤α4/α3≤50; and the focal length F_{T} of the emitting terminal lens assembly and the defocus range d of the light source satisfy the following relationship: d/F_{T}≤0.2; preferably, 0.08≤d/F_{T}≤0.18.

In a feasible implementation, when the light source processing element includes the emitting terminal lens assembly and the microlens array, then the emitting terminal lens assembly and the microlens array may be set to be affixed or non-affixed;

If the emitting terminal lens assembly and the microlens array are set to be affixed together, a curvature of a last surface of the emitting terminal lens assembly coincides with a curvature of an affixing surface of the microlens array.

By setting the emitting terminal lens assembly and the microlens array to be affixed, a total length of the emitting terminal may be effectively reduced, thereby reducing a total length of the entire optical system, which is conducive to miniaturization of the optical system. By setting the two affixing surfaces to have the same curvature, such as both being convex-surface or concave-surface or planar-surface structures, a matching degree after the affixing may be ensured, so as to improve the light-homogenizing and diffusion effect.

In a feasible implementation, since the emitting terminal lens assembly may often also be provided with an optical window for protection, the microlens array may be affixed to the optical window or integrally molded with the optical window, which is also conducive to the miniaturization of the optical system.

In a feasible implementation, the emitting terminal lens assembly may contain only one emitting terminal lens.

In particular, relative to the emitting terminal lens assembly with the original combination of multiple lenses, by setting only one emitting terminal lens, it may realize the expansion of light spot, improve the homogeneity of light beam, and likewise realize the function of homogenizing and diffusion processing on the light beam.

The emitting terminal provided in the present embodiment, by setting a light source, which is configured to emit a row and/or column of light beam for detecting a target object; and a light source processing element, which is configured to process the row and/or column of light beam emitted by the light source to obtain a diffused row and/or column of light beam, enables the light source to achieve dark zone-free illumination between rows or between columns without loss of energy from the light source by means of homogenizing and diffusion processing of the light source processing element when the light source emitting one row/column or multiple rows/columns, thereby increasing the volume of scanning information captured by relying on a light source illumination area, which is conducive to reducing loss of scanning information of a scanning system.

Implementations of the present disclosure also provide an optical system, including: an emitting terminal; and a target object, for receiving and reflecting a row and/or column of light beam emitted by the emitting terminal; and a receiving terminal, configured to receive the row and/or column of light beam reflected by the target object, where an area of the row and/or column of light beam received by the receiving terminal is larger than an area of the row and/or column of light beam emitted by the emitting terminal.

In a feasible implementation, the receiving terminal includes a receiving terminal lens assembly and a receiving chip, and the size of the receiving chip used is proportional to the size of the light source at the emitting terminal, e.g., the light source at the emitting terminal is an array light source with M rows*N columns (VCSEL light source), and the receiving chip is an array chip with m rows*n columns (SPAD chip), then m/M≥1, n/N≥1. This setup makes a backend processing circuit of the light source simple and low-cost. At the same time, since the light beam is amplified and processed, there is no need to set up a large size light source, thus effectively reducing the size of the light source, and effectively reducing an overall design volume of the system.

In a feasible implementation, the emitting terminal includes a light source and an emitting terminal lens assembly, the light beam emitted by the light source is homogenized and diffused by the emitting terminal lens assembly, and then irradiated to a surface of the target object, the surface of the target object reflects due to light irradiation, the reflected light beam is received by the receiving terminal lens assembly and then converged, and then sent to the receiving chip.

Here, the receiving terminal lens assembly may have a similar distortion to the emitting terminal lens assembly, to ensure matching of the receiving terminal with the emitting terminal, thus improving a transceiver detection efficiency of the system.

In a feasible implementation, a distortion F_{θ1} of the emitting terminal lens assembly and a distortion Fθ2 of the receiving terminal lens assembly satisfy: 0.5≤|Fθ1/Fθ2|≤1.5; or, |Fθ1/Fθ2−1|≤0.1.

In another feasible implementation, the receiving terminal includes the human eye, in this regard, the human eye directly receives the light beam reflected by the target object, since after homogenizing and diffusion processing at the emitting terminal, there are no dark zones in the reflected light beam from the target object observed by the human eye, thus enabling the human eye to capture a homogenizing illuminated reflection image.

The optical system of implementations of the present disclosure is described in detail below in conjunction with detailed embodiments, where the light sources are all VCSEL light sources and the receiving chips are all SPAD chips.

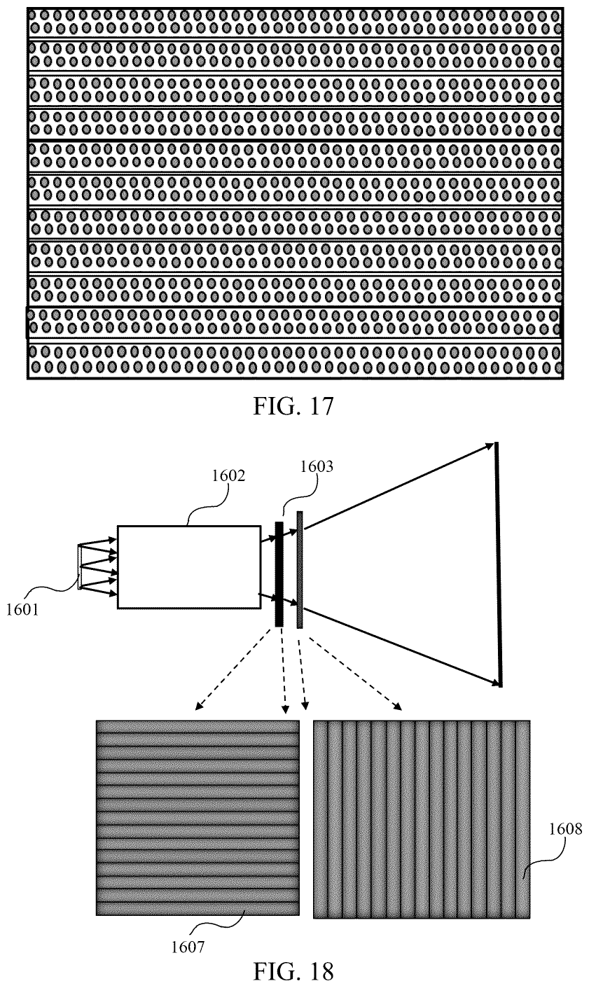

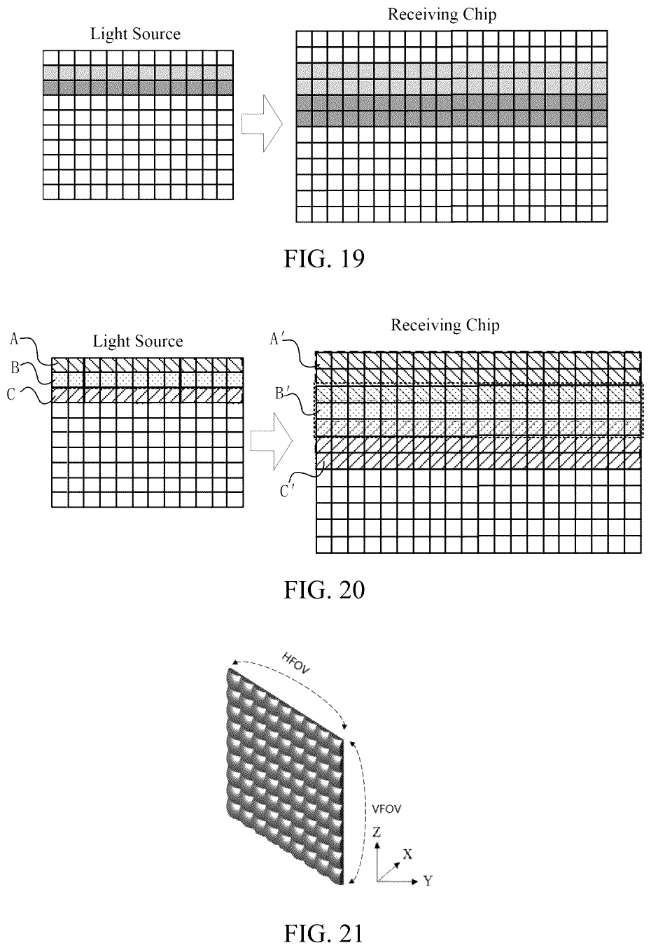

FIG. 16 shows a schematic structure diagram I of an optical system provided by embodiments of the present disclosure; FIG. 17 shows a schematic structure diagram of a light source provided by embodiments of the present disclosure; FIG. 18 shows a schematic structure diagram II of an emitting terminal provided by embodiments of the present disclosure; and FIG. 19 shows a schematic diagram I of a lit state of a light source and a receiving chip of an optical system provided by embodiments of the present disclosure.

As shown in FIG. 16, the optical system includes: an emitting terminal, a target object 1604, a receiving terminal lens assembly 1605, and a receiving chip 1606; where, the emitting terminal includes a light source 1601, an emitting terminal lens assembly 1602, and a double-row orthogonal microlens array 1603.

As shown in FIG. 17, black shaded holes in the figure are light-emitting holes, and the light-emitting holes in the light source are arranged in multiple channels, with a single row or multiple rows of light-emitting holes provided in each channel, and the light-emitting hole may be small-diameter circular light-emitting holes.

An overall divergence angle of the optical system is 128° *96°, and a size ratio of VCSEL light source to SPAD chip is 1:3.

As shown in FIG. 18, the double-row orthogonal microlens array 1603 includes microlens units 1607 arranged in a transverse direction and microlens units 1608 arranged in a longitudinal direction.

Here, the transversely arranged microlens units 1607 are used to homogenize and diffuse in the vertical direction, and a range of values satisfies: 2≤|radius of curvature R1 of the microlens unit/diameter D1 of the microlens unit|≤100.

The longitudinally arranged microlens units 1608 are used to homogenize and diffuse in the horizontal direction, and a range of values satisfies: 2≤|radius of curvature R2 of the microlens unit/diameter D2 of the microlens unit|≤70.

The plurality of single-row microlens units arranged in the same direction are randomized in thickness, with a random range≤⅓*microlens thickness d, and maximum value dmax of microlens thickness/minimum value dmin of microlens thickness≤2.

The plurality of horizontally single-row microlens units arranged in the same direction are randomized in radius of curvature in the horizontal direction, with a random range of 0.5≤|R1max/R1 min|≤1.5.

The plurality of single-row microlens units arranged in the same direction are randomized in radius of curvature in the vertical direction, with a random range of 0.5≤|R2max/R2 min|≤1.5.

The plurality of single-row microlens units arranged in the same direction are randomized in central point arrangement in the horizontal direction, the central points are randomly arranged in the horizontal direction, and random range≤⅓*horizontal diameter D1 of the microlens unit.

The plurality of single-row microlens units arranged in the same direction are randomized in central point arrangement in the vertical direction, the central points are randomly arranged in the vertical direction, and random range≤⅓*vertical diameter D2 of the microlens unit.

A horizontal field-of-view HFOV of the emitting terminal lens assembly, the horizontal radius of curvature R1 and the horizontal diameter D1 of the microlens unit satisfy: HFOV/(R1/D1)≤16.

Here, 0.005 mm≤D1≤1 mm; 0.1 mm≤R1≤20 mm.

The distortion of the emitting terminal lens assembly and the distortion of the receiving terminal lens assembly are the same, i.e., |Fθ_{TX}/Fθ_{RX}|=1. A matching efficiency between the receiving terminal and the emitting terminal is up to 98%.

As shown in FIG. 19, by curvature change of the double-row orthogonal microlens array, diffused light beam edges of the light source on the receiving chip are controlled to not be superimposed.

The optical system has a post-homogenization collimation degree α2/pre-homogenization collimation degree α1=3.2. A focal length F_{T} of the emitting terminal lens assembly=2 mm; the HFOV is 128°; the number of light-emitting holes C in a single row of channel in the horizontal direction=60; a diameter Le of a single light-emitting hole of the light source=30 μm; and F_{T}*2 tan(HFOV/2)/C/Le=4.556.

The optical system provided in the present embodiment, by using the light source array and receiving chip array in proportional relationship and using the microlens array to homogenize and diffuse the light beam in both horizontal and vertical directions simultaneously, realizes that a single row/column of light sources lit multiple rows/columns of receiving chips while improving a brightness homogeneity of the light beam after diffusion, further, diffusion of a to-be-scanned area on the target object caused by pixel defects of the light source array is realized by means of flood-line scanning, which reduces the size of the light source array and at the same time reduces a size of the emitting terminal lens assembly that matches the light source array, thereby reducing the overall size and cost of the system.

FIG. 20 shows a schematic diagram II of a lit state of a light source and a receiving chip of the optical system provided by embodiments of the present disclosure; and FIG. 21 shows a schematic structure diagram of a two-dimensional microlens array provided by embodiments of the present disclosure. The optical system is structurally similar to the optical system in the previous embodiment, differing only in that the double-row orthogonal microlens array is replaced with the two-dimensional microlens array that only homogenizes and diffuses one row/column of light beam.

The light-emitting holes in the light source are arranged in multiple channels, with three rows of light-emitting holes provided in each channel, and the light-emitting holes are small-diameter circular light-emitting holes.

An overall divergence angle of the optical system is 128° *96°, and a size ratio of VCSEL light source to SPAD chip is 1:3.

As shown in FIG. 21, the two-dimensional microlens array includes a plurality of microlens units of block-like structure arranged in an array in both horizontal and vertical directions.

The two-dimensional microlens array simultaneously diffuses and homogenizes the light beam in the horizontal and vertical directions, and a range of values satisfies: 2≤|radius of curvature R1 of a microlens unit/diameter D1 of the microlens unit|≤100, 2≤|radius of curvature R2 of a microlens unit/diameter D2 of the microlens unit|≤70.

The plurality of microlens units are randomized in thickness, random range≤⅓*microlens thickness d, and maximum value dmax of microlens thickness/minimum value dmin of microlens thickness≤2.

The plurality of microlens units are randomized in radius of curvature in the horizontal direction, with a random range of 0.5≤|R1max/R1 min|≤1.5.

The plurality of microlens units are randomized in radius of curvature in the vertical direction, with a random range of 0.5≤|R2max/R2 min|≤1.5.

The plurality of microlens units are randomized in central point arrangement in the horizontal direction, the central points are randomly arranged in the horizontal direction, and random range≤⅓*horizontal diameter D1 of the microlens unit.

The plurality of microlens units are randomized in central point arrangement in the vertical direction, the central points are randomly arranged in the vertical direction, and random range≤⅓*vertical diameter D2 of the microlens unit.

A horizontal field-of-view HFOV of the emitting terminal lens assembly, the horizontal radius of curvature R1 and the horizontal diameter D1 of the microlens unit satisfy: HFOV/(R1/D1)≤16.

Here, 0.005 mm≤D1≤1 mm; 0.1 mm≤R1≤20 mm.

The distortion of the emitting terminal lens assembly and the distortion of the receiving terminal lens assembly are different, i.e., |Fθ_{TX}/Fθ_{RX}|=1.1. A matching efficiency between the receiving terminal and the emitting terminal is up to 96%.

As shown in FIG. 20, curvature changes of the two-dimensional array of microlenses are used to control superimposition of edge portions of diffusion beams A′, B′, and C′ of light sources A, B, and C on the receiving chip, to eliminate fluctuations caused by spacing of the light sources and to further avoid the generation of dark zones.

For the optical system, a post-homogenization collimation degree α2/pre-homogenization collimation degree α1=4. A focal length F_{T} of the emitting terminal lens assembly=2.8 mm; the HFOV is 128°; the number of light-emitting holes C in a single row of channel in the horizontal direction C=68; a diameter Le of a single light-emitting hole of the light source=33 μm; and F_{T}*2 tan(HFOV/2)/C/Le=5.116.

The optical system provided in the present embodiment, by using the light source array and receiving chip array in proportional relationship and using the microlens array to homogenize and diffuse the light beam in both horizontal and vertical directions simultaneously, realizes that a single row/column of light sources lit multiple rows/columns of receiving chips while improving a brightness homogeneity of the light beam after diffusion, further, diffusion of a to-be-scanned area on the target object caused by fluctuations in the light source spacing is realized, which reduces a size of the emitting terminal lens assembly that matches the light source array, thereby reducing the overall size and cost of the system.

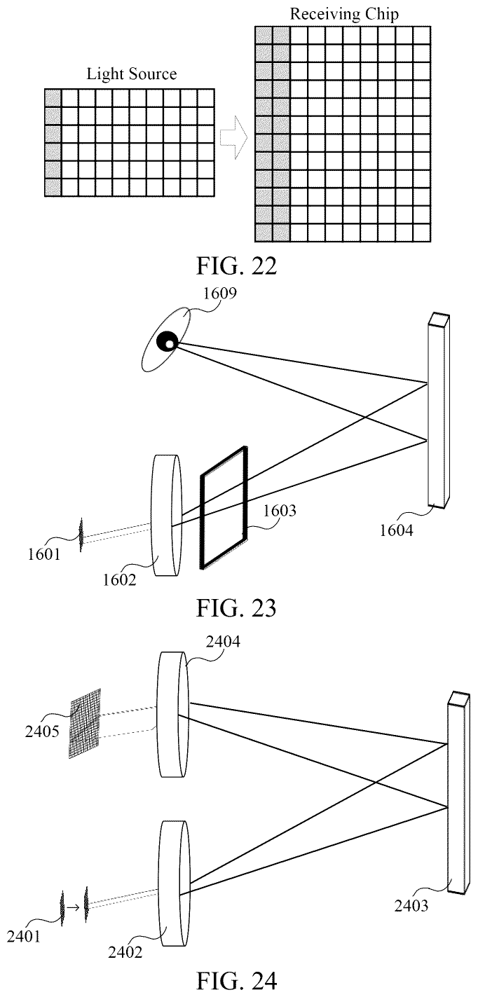

FIG. 22 shows a schematic diagram III of a lit state of a light source and a receiving chip of the optical system provided by embodiments of the present disclosure. The optical system is structurally similar to the optical system in the previous embodiment, differing only in that the light source is collimated to form one column of beam that are emitted into the two-dimensional microlens array.

The light-emitting holes in the light source are arranged in multiple channels, with a single row or multiple rows of light-emitting holes provided in each channel, and the light-emitting holes are small-diameter circular light-emitting holes.

An overall divergence angle of the optical system is 128° *96°, and a size ratio of VCSEL light source to SPAD chip is 1:2.1.

The two-dimensional microlens array simultaneously diffuses and homogenizes in the horizontal and vertical directions, and a range of values satisfies: 2≤|radius of curvature R1 of a microlens unit/diameter D1 of the microlens unit|≤100, 2≤|radius of curvature R2 of a microlens unit/diameter D2 of the microlens unit|≤70.

The plurality of microlens units are randomized in thickness, random range≤⅓*microlens thickness d, and maximum value dmax of microlens thickness/minimum value dmin of microlens thickness≤2.

The plurality of microlens units are randomized in radius of curvature in the horizontal direction, with a random range of 0.5≤|R1max/R1 min|≤1.5.

The plurality of microlens units are randomized in radius of curvature in the vertical direction, with a random range of 0.5≤|R2max/R2 min|≤1.5.

The plurality of microlens units are randomized in central point arrangement in the horizontal direction, the central points are randomly arranged in the horizontal direction, and random range≤⅓*horizontal diameter D1 of the microlens unit.

The plurality of microlens units are randomized in central point arrangement in the vertical direction, the central points are randomly arranged in the vertical direction, and random range≤⅓*vertical diameter D2 of the microlens unit.

A horizontal field-of-view HFOV of the emitting terminal lens assembly, the horizontal radius of curvature R1 and the horizontal diameter D1 of the microlens unit satisfy: HFOV/(R1/D1)≤16.

Here, 0.005 mm≤D1≤1 mm; 0.1 mm≤R1≤20 mm.

The distortion of the emitting terminal lens assembly and the distortion of the receiving terminal lens assembly are different, i.e., |Fθ_{TX}/Fθ_{RX}|=0.9. A matching efficiency between the receiving terminal and the emitting terminal is up to 97%.

As shown in FIG. 22, curvature changes of the two-dimensional array of microlenses are used to control longitudinal diffusion of the light beam of a single column of light on the receiving chip, thus realizing diffusion by means of floodlighting and completing efficient matching of the receiving terminal with the emitting terminal.

For the optical system, a post-homogenization collimation degree α2/pre-homogenization collimation degree α1=3.2. A focal length F_{T} of the emitting terminal lens assembly=2.2 mm; the HFOV is 126°; the number of light-emitting holes C in a single row of channel in the horizontal direction C=56; a diameter Le of a single light-emitting hole of the light source=32 μm; and F_{T}*2 tan(HFOV/2)/C/Le=4.819.

The optical system provided in the present embodiment, by using the light source array and receiving chip array in proportional relationship and using the microlens array to homogenize and diffuse the light beam in both horizontal and vertical directions simultaneously, realizes that a single column of light sources lit multiple columns of receiving chips while improving a brightness homogeneity of the light beam after diffusion, thus realizing diffusion of a to-be-scanned area on the target object.

FIG. 23 shows a schematic structure diagram II of the optical system provided by embodiments of the present disclosure. As shown in FIG. 23, the optical system is similar in structure to that in the above embodiments, and the parameter settings are the same, differing only in that there is no emitting terminal lens assembly and receiving chip, and a human eye 1609 is set up as the receiving terminal of the reflected beam from the target object 1604, so as to enable the human eye to receive a picture without dark zones, and to realize homogeneous illumination of the entire picture.

FIG. 24 shows a schematic structure diagram III of an optical system provided by embodiments of the present disclosure; and FIG. 27 shows a schematic diagram IV of a lit state of a light source and a receiving chip of the optical system provided by embodiments of the present disclosure.

As shown in FIG. 24, the optical system includes: the emitting terminal, a target object 2403, a receiving terminal lens assembly 2404, and a receiving chip 2405; where, the emitting terminal includes a light source 2401 and an emitting terminal lens assembly 2402.

The light-emitting holes in the light source are arranged in multiple channels, with a single row or multiple rows of light-emitting holes provided in each channel, and the light-emitting holes are small-diameter circular light-emitting holes.

An overall divergence angle of the optical system is 128°*96°, and a size ratio of VCSEL light source to SPAD chip is 1:2.

The distortion of the emitting terminal lens assembly and the distortion of the receiving terminal lens assembly are the same, i.e., |Fθ_{TX}/Fθ_{RX}|=1. A matching efficiency between the receiving terminal and the emitting terminal is up to 98%.

The light source is translated a certain distance back and forth in a propagation direction of the light of the optical system, and an overall correlation is quantized to realize that the light source is defocused, so that the light of the system can be homogenized and diffused; where, a defocus range d is 0.03, and a focal length F_{T} of the lens assembly is 3, and d/F_{T}≤0.2.

As shown in FIG. 27, through defocusing of the light source, single row of light-emitting holes is controlled to diffuse the light beam in all directions on the receiving chip, so as to realize diffusion and complete efficient matching of the emitting terminal with the receiving terminal.

The optical system provided in the present embodiment, by defocusing the light source, a light-emitting area in the light source array is homogenized and diffused, the use of defocusing adjusts the divergence angle of the light source, and at the same time improves homogeneity of the light, thus achieving an effect of compensating for dark zones by means of floodlighting.

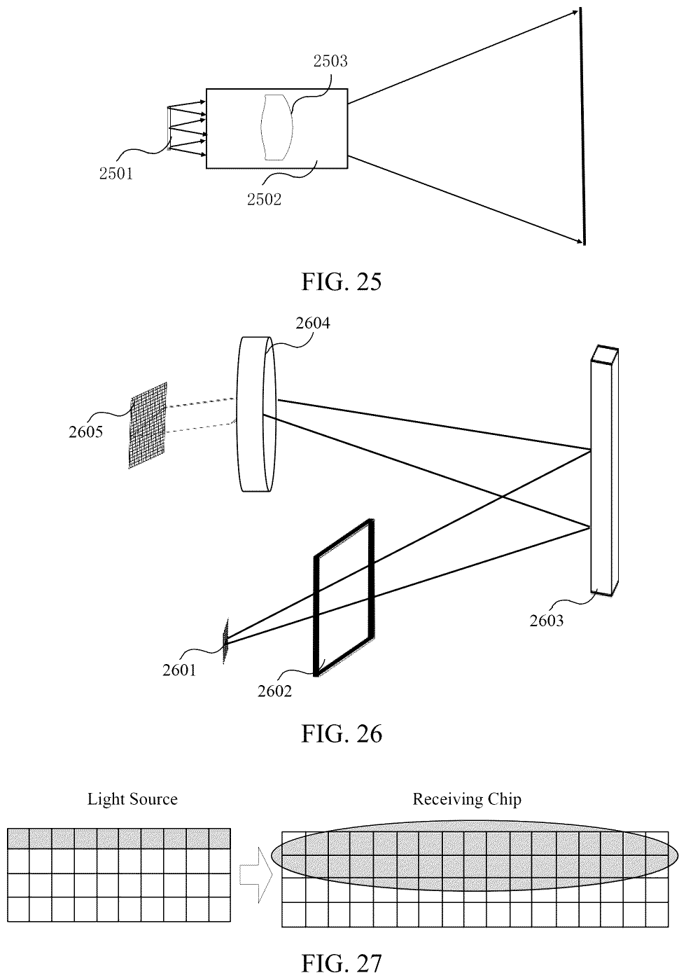

FIG. 25 shows a schematic structure diagram III of an emitting terminal provided by embodiments of the present disclosure. The structure of the optical system adopts a similar structure as shown in FIG. 16, differing only in that the present embodiment adopts the emitting terminal as shown in FIG. 25. The emitting terminal includes a light source 2501 and an emitting terminal lens assembly 2502, which contains only one emitting terminal lens 2503, and a single-row light beam emitted by the light source 2501 is collimated by the one emitting terminal lens 2503 and then emitted to the target object.

The light-emitting holes in the light source are arranged in multiple channels, with a single row or multiple rows of light-emitting holes provided in each channel, and the light-emitting holes are small-diameter circular light-emitting holes.

An overall divergence angle of the optical system is 120° *90°.

The distortion of the emitting terminal lens assembly and the distortion of the receiving terminal lens assembly are different, i.e., |Fθ_{TX}/Fθ_{RX}|=1.05. A matching efficiency between the receiving terminal and the emitting terminal is up to 94%.

The optical system has a post-homogenization collimation degree α2/pre-homogenization collimation degree α1=8.

The optical system provided in the present embodiment, by reducing the number of lenses in the emitting terminal lens assembly, such as reducing the number of 5 lenses to 3 lenses or 1 lens, expands the light spot of flood-line, improves light beam homogeneity, thus achieving an effect of compensating for dark zones by means of floodlighting.

FIG. 26 shows a schematic structure diagram IV of an optical system provided by embodiments of the present disclosure. As shown in FIG. 26, the optical system includes: a light source 2601, a two-dimensional microlens array 2602, a target object 2603, a receiving terminal lens assembly 2604, and a receiving chip 2605.

The light-emitting holes in the light source are arranged in multiple channels, with a single row or multiple rows of light-emitting holes provided in each channel, and the light-emitting holes are small-diameter circular light-emitting holes.

An overall divergence angle of the optical system is 128° *96°.

The two-dimensional microlens array simultaneously diffuses and homogenizes light in the horizontal and vertical directions, and a range of values satisfies: 2≤|radius of curvature R1 of a microlens unit/diameter D1 of the microlens unit|≤100, 2≤|radius of curvature R2 of a microlens unit/diameter D2 of the microlens unit|≤70.

The plurality of microlens units are randomized in thickness, random range≤⅕*microlens thickness d.

The plurality of microlens units are randomized in radius of curvature in the horizontal direction, with a random range of 0.5≤|R1max/R1 min|≤1.5.

The plurality of microlens units are randomized in radius of curvature in the vertical direction, with a random range of 0.5≤|R2max/R2 min|≤1.5.

The plurality of microlens units are randomized in central point arrangement in the horizontal direction, the central points are randomly arranged in the horizontal direction, and random range≤⅓*horizontal diameter D1 of the microlens unit.

The plurality of microlens units are randomized in central point arrangement in the vertical direction, the central points are randomly arranged in the vertical direction, and random range≤⅓*vertical diameter D2 of the microlens unit.

A matching efficiency between the receiving terminal and the emitting terminal is up to 95%.

The optical system provided in the present embodiment, does not use an emitting terminal lens assembly, so that the light beam emitted by the light source is directly emitted to the target object after being diffused by the two-dimensional microlens array, thus realizing diffusion of a scanning area due to pixel defects.

The present embodiment also provides a lidar, using the optical system described in any one of the above embodiments.

Detailed implementation of the lidar of the present embodiment can be referred to in the above optical system embodiments, which have similar implementation principles and technical effects, which will be omitted herein in the present embodiment.

Some further example embodiments of the present disclosure also propose an optical system. A detailed application scenario of the optical system of the present disclosure is as follows.

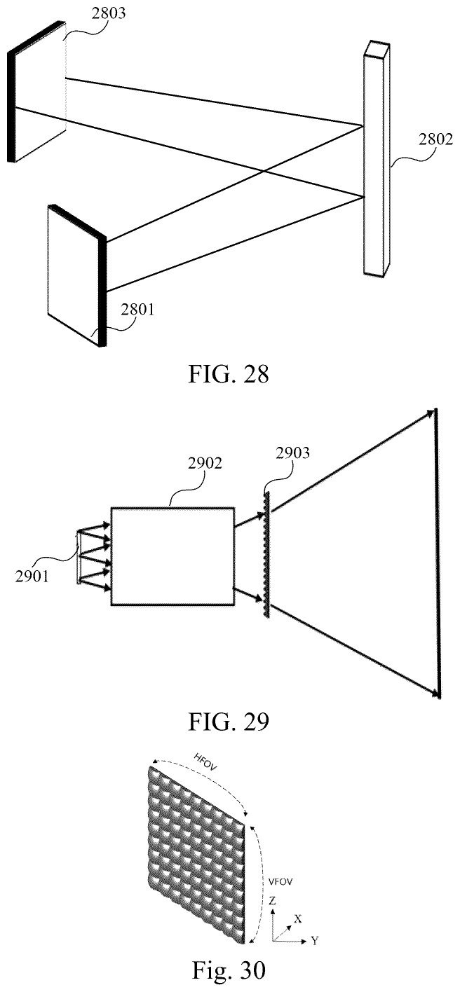

FIG. 28 shows a schematic diagram of an application scenario of an optical system provided by embodiments of the present disclosure. As shown in FIG. 28, the optical system 2801 emits a light beam to irradiate to a target object 2802, and reflected light beam of the target object 2802 is captured by a detector receiving terminal 2803 to form a light signal associated with the target object 2802, so as to infer the target object 2802 inversely based on the light signal, thereby realizing a scanning function of a scanning detection device, such as a lidar.

FIG. 29 shows a schematic structure diagram I of an optical system provided by embodiments of the present disclosure; and FIG. 30 shows a schematic structure diagram of a microlens array provided by embodiments of the present disclosure. As shown in FIG. 29, the optical system includes: a light source, configured to emit an area light beam for detecting the target object; and at least one microlens array, configured to homogenize and diffuse the light beam, each of the microlens array includes a plurality of microlens units, and the plurality of microlens units are arranged and set correspondingly based on a homogenous diffusing direction of the area light beam.

In particular, the area light beam is emitted by the light source, and the area light beam may be composed of rows and columns, and an area shape is not limited, but may be any shape such as square, rectangle, or triangle, so that lens assembly distortion may be quickly determined according to needs of the applied lidar system in order to improve a matching efficiency of the lens assembly; and the number of the area light beams is not limited either, but may be one, two, three, four, and so on, and it is only needs to ensure that multiple simultaneously emitted area light beams are not adjacent to each other and do not overlap.

As shown in FIG. 30, the microlens array may include a plurality of microlens units of block-like structure arranged in an array in both horizontal and vertical directions.

In another feasible embodiment, the microlens array includes a mutually orthogonal combination of a microlens array for horizontally homogenizing and diffusing light and a microlens array for vertically homogenizing and diffusing light, and the combination may be set to be affixed or non-affixed.

In a feasible embodiment, an emitting terminal lens assembly may also be included, for diverging or collimating the area beam emitted by the light source; a horizontal field-of-view HFOV of the emitting terminal lens assembly, a horizontal radius of curvature R1 and a horizontal diameter D1 of a microlens unit satisfy the following relationship: HFOV/(|R1|/D1)≤16°; preferably, HFOV/(|R1|/D1)≤8°.

In particular, the setting parameters of the emitting terminal lens assembly and the microlens unit are conducive to homogenization of energy of the light beam, which can enable to obtain a better light-homogenizing and diffusion effect on the light beam in the horizontal direction, and is conducive to compensating for dark zones.

In a feasible embodiment, the horizontal radius of curvature R1 of a microlens unit and a vertical radius of curvature R2 of the microlens unit may satisfy the following relationship: |R1/R2|≤10.

In particular, the relationship of the radius of curvature parameters of the microlens unit provides better control of the angle of light, improves an imaging ability of the system and improves a field-of-view, which is conducive to matching of the emitting terminal with the receiving terminal.

In a feasible embodiment, the horizontal radius of curvature R1 and the horizontal diameter D1 of a microlens unit may satisfy the following relationship: 50≤|R1/D1|≤100; and/or the vertical radius of curvature R2 and a vertical diameter D2 of the microlens unit may satisfy the following relationship: 50≤|R2/ D2|≤100.

In particular, an array of single-row microlens units in the horizontal direction and an array of single-row microlens units in vertical direction are replaced with an array of block-shaped microlens units having both radius of curvature and diameter characteristics in both the horizontal and vertical directions, to achieve a homogenizing and diffusing function.

In a feasible embodiment, a thickness of the microlens unit is a thickness random value, and a magnitude of variation d0 of the thickness random value and a preset thickness d may satisfy the following relationship: d0≤⅕*d.

In particular, the thickness random value makes the thicknesses of multiple neighboring microlens units not uniform therebetween, but fluctuates within a certain range, thus avoiding the influence of diffraction due to uniformity of thicknesses and substantially suppressing a diffraction effect.

In a feasible embodiment, the horizontal radii of curvature of the microlens units are a horizontal radius of curvature random values, and a maximum horizontal radius of curvature random value R1max and a minimum horizontal radius of curvature random value R1 min in the horizontal radius of curvature random values may satisfy the following relationship: 0.5≤R1max/R1 min≤1.5; the vertical radii of curvature of the microlens units are vertical radius of curvature random values, and a maximum vertical radius of curvature random value R2max and a minimum vertical radius of curvature random value R2 min in the vertical radius of curvature random values may satisfy the following relationship: 0.5≤R2max/R2 min≤1.5.

In particular, the radii of curvature in both the horizontal and vertical directions are set to random values that fluctuate within a certain range, thus avoiding the influence of diffraction due to uniformity of radii of curvature and substantially suppressing the diffraction effect.

In a feasible embodiment, horizontal central points of the array of microlenses are horizontal diameter random values, and a magnitude of variation D3 of a horizontal diameter random value and a preset horizontal diameter D4 may satisfy the following relationship: |D3|≤⅓*D4; and vertical central points of the array of microlenses are vertical diameter random values, and a magnitude of variation D4 of a vertical diameter random value and a preset vertical diameter D6 may satisfy the following relationship: |D4|≤⅓*D6.

In particular, the horizontal central points and the vertical central points of the array of microlenses are arranged randomly, which ensures a light-homogenizing and diffusion effect, and is conducive to eliminating diffraction.

In a feasible embodiment, an emitting terminal lens assembly may also be included, for diverging or collimating the area light beam emitted by the light source; a pre-homogenization collimation degree α1 and a post-homogenization collimation degree α2 of the light source, the horizontal field-of-view HFOV of the emitting terminal lens assembly, a focal length F_{T} of the emitting terminal lens assembly, the number of horizontal single-column light sources C, and a size Le of a single light-emitting hole of the light source satisfy the following irradiation area relationship: 1≤α2/α1≤F_{T}*2 tan(HFOV/2)/C/Le; where, α1>0, 1≤F_{T}*2 tan(HFOV/2)/C/Le≤35; preferably, F_{T}*tan(HFOV/2)/C/Le≤α2/α1≤F_{T}*2 tan(HFOV/2)/C/Le.

In particular, the setting parameters enable each light source to be fully and effectively used in the horizontal direction, avoiding energy loss and thus enhancing a light-homogenizing and diffusion effect.

In a feasible embodiment, a focal length F1 of the microlens unit in the horizontal direction and a focal length F2 of the microlens unit in the vertical direction may satisfy the following relationship: |F1/F2|≤5.

In particular, since different focal lengths have different homogenizing and diffusing effects on the light beam, the setting of this focal length ratio range parameter is conducive to achieving homogenization of light beam energy within a specific light beam width range, thereby better enhancing the light-homogenizing and diffusing effect of the system.

In a feasible embodiment, an emitting terminal lens assembly may also be included, for diverging or collimating the area light beam emitted by the light source; the emitting terminal lens assembly and the microlens array are set to be affixed or non-affixed.

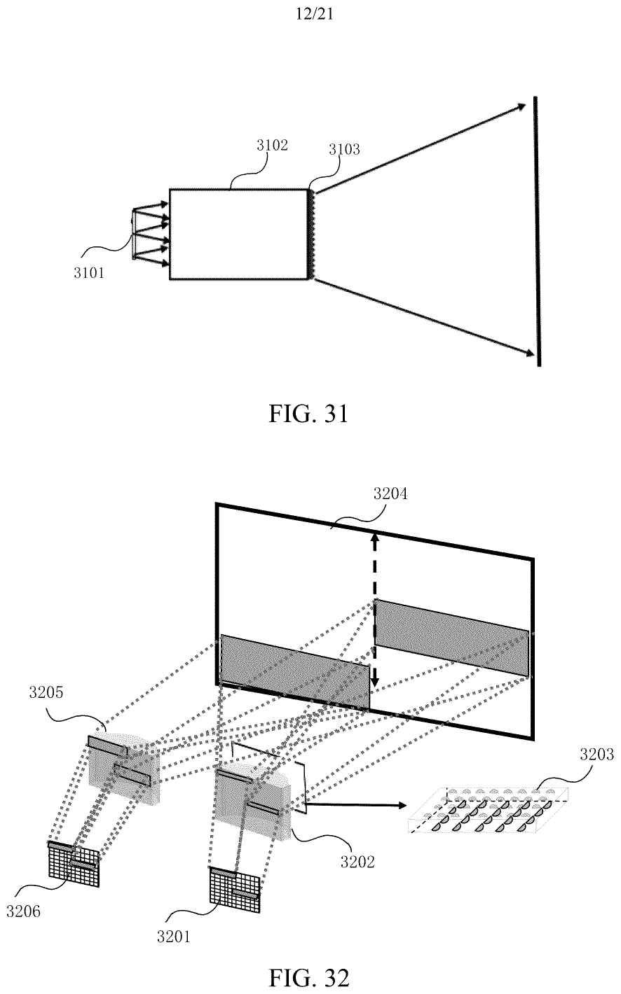

FIG. 31 shows a schematic structure diagram II of an optical system provided by embodiments of the present disclosure. As shown in FIG. 31, the emitting terminal lens assembly and the microlens array are set to be affixed, and a curvature of a last surface of the emitting terminal lens assembly coincides with a curvature of an affixing surface of the microlens array.

In particular, by setting the emitting terminal lens assembly and the microlens array to be affixed, a total length of the emitting terminal of flood-line scanning may be effectively reduced, thereby reducing a total length of the entire optical system, which is conducive to miniaturization of the optical system. By setting the two affixing surfaces to have the same curvature, such as both being convex-surface or concave-surface or planar-surface structures, a matching degree after the affixing may be ensured, so as to improve a light-homogenizing and diffusion effect.

In a feasible embodiment, since the emitting terminal lens assembly may often also be provided with an optical window for protection, the microlens array may be affixed to the optical window or integrally molded with the optical window, which is also conducive to the miniaturization of the optical system.

In a feasible embodiment, the light source, is configured to simultaneously emit at least two area light beams of a preset shape and perform cyclic scanning, a plurality of the area light beams of the preset shape being always non-adjacent in the scanning process.

In a feasible embodiment, the light source, is further configured to emit a single row/column of area light beam.

In a feasible embodiment, the light source, is further configured to emit an area light beam of certain shape for eliminating a distortion of the emitting terminal lens assembly.

In a feasible embodiment, when the area light beam of the preset shape is a block-shaped area light beam, a length M and a width N of the area light beam and a length m and a width m of a light beam detected by a receiving chip of the lidar system may satisfy the following relationship: m/M≥1, n/N≥1; where, 1≤m≤8, 1≤n≤8.

The optical system provided in the present embodiment, by setting a light source, configured to emit an area light beam for detecting the target object; and at least one microlens array, configured to homogenize and diffuse the light beam, each of the microlens array includes a plurality of microlens units, and the plurality of microlens units are arranged and set correspondingly based on a homogenous diffusing direction of the area light beam, so that the area light beam emitted by the light source is homogenized and diffused by the emitting terminal lens assembly and the microlens array, achieves dark zone-free illumination between areas without loss of energy from the light source, thereby increasing the volume of scanning information captured by relying on a light source illumination area, which is conducive to improving a detection accuracy of a detection system.

FIG. 32 shows a schematic structure diagram of a lidar system provided by embodiments of the present disclosure. As shown in FIG. 32, the lidar system includes: an optical system; and a target object, for receiving and reflecting an area light beam emitted by the optical system; a receiving terminal, for receiving the area light beam reflected by the target object, an area of the area light beam received by the receiving terminal being not smaller than an area of the area light beam emitted by the optical system; where, the receiving terminal includes a receiving terminal lens assembly and a receiving chip; the receiving terminal lens assembly, is configured to converge the area light beam reflected by the target object, and the receiving terminal lens assembly is co-distortion with the emitting terminal lens assembly in the optical system; and the receiving chip, is configured to detect and receive the converged area light beam.

### Flood-Area Scanning

An emitting terminal may include a light source, an emitting terminal lens assembly, and a microlens array.

In a feasible embodiment, a distortion Fθ_{TX} of the emitting terminal lens assembly and a distortion Fθ_{RX} of the receiving terminal lens assembly may satisfy the following relationship: 0.3≤|Fθ_{TX}/Fθ_{RX}|≤3; or, |Fθ_{TX}/Fθ_{RX}−1≤0.1.

In particular, co-distortion setting of the emitting terminal lens assembly and the receiving terminal lens assembly may ensure that the emitting terminal and the receiving terminal are matched to ensure the detection efficiency of the system. Therefore, the amount of distortion of the emitting terminal lens assembly and the receiving terminal lens assembly may be limited to a certain range to improve a matching efficiency between the receiving terminal and the emitting terminal.

Here, the aberration Fθ_{TX} of the emitting terminal lens assembly may satisfy the following equation: Fθ_{TX}=((Y−Y0)/Y0)×100%, where, Y is an actual image height of the emitting terminal lens assembly, and Y0 is an ideal image height of the emitting terminal lens assembly; the distortion Fθ_{RX} of the receiving terminal lens assembly may satisfy the following equation: Fθ_{RX}=((Y′−Y0′)/Y0′)×100%, where, Y′ is an actual image height of the receiving terminal lens assembly, and Y0′ is an ideal image height of the receiving terminal lens assembly.

In a feasible embodiment, a total track length L1 of the optical system and a total track length L2 of the receiving terminal may satisfy the following relationship: L2/L1≤3; or, 0.5≤L2/L1≤2; where, the total track length L1 of the optical system is used to identify a distance between the light source and a light output surface of the microlens array, and the total track length L2 of the light source at the receiving terminal is used to identify a distance between a reflected light receiving surface of the receiving terminal lens assembly and the receiving chip.

In particular, limiting the optical length ratio between the emitting terminal and the receiving terminal, to improve a matching efficiency between the receiving terminal and the emitting terminal.

The lidar system provided by embodiments of the present disclosure includes: a light source, an emitting terminal lens assembly, and a microlens array; and a target object, for receiving and reflecting an area light beam emitted by the optical system; a receiving terminal, for receiving the area light beam reflected by the target object, an area of the area light beam received by the receiving terminal being not smaller than an area of the area light beam emitted by the optical system; where, the receiving terminal includes a receiving terminal lens assembly and a receiving chip; the receiving terminal lens assembly, is configured to converge the area light beam reflected by the target object, and the receiving terminal lens assembly is co-distortion with the emitting terminal lens assembly in the optical system; and the receiving chip, is configured to detect and receive the converged area light beam. The area light beam lighting method may avoid the receiving chip to receive optical information with large background noise caused by single line lighting, reduce the lack of information caused by effective signal annihilation. Co-distortion of the emitting terminal lens assembly and the receiving terminal lens assembly improves the matching efficiency between the receiving terminal and the emitting terminal, which is conducive to stability and miniaturization of the system. The microlens array controls the light-emitting angle and homogeneity of the area light beam emitted by the light source, while using the matching emitting terminal lens assembly and receiving terminal lens assembly, enables the receiving chip to receive more complete information. Through a light-homogenizing and diffusion effect of the microlens array, a small area of light source lit ragion corresponds to a large area of receiving chip lit area, thus realizing compensation of dark zones in the detection area caused by pixel defects in the light source, reducing the size of the light source while reducing an overall volume of the lidar system, which is conducive to realizing miniaturization of the apparatus and lowering a configuration cost of the apparatus.

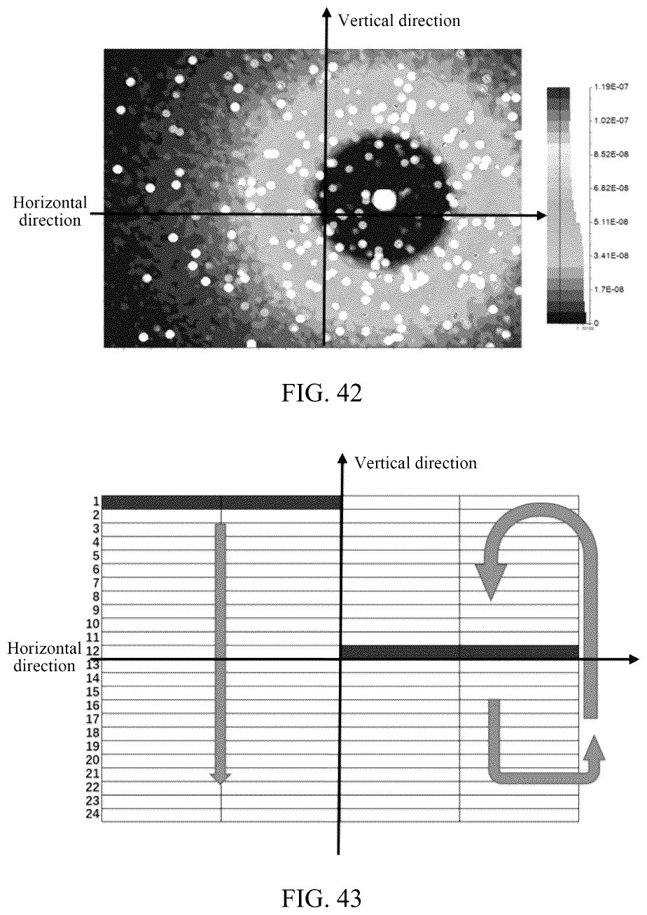

FIG. 42 shows a simulation diagram of energy level distribution received by a receiving chip of an existing lidar system. As shown in FIG. 42, under the influence of mutual reflection of light between lenses and structural components within the lidar system, when the light source in a certain area is lit, a ring of light halo may be formed around an imaging area, thus making the right half portion of a detection area have a higher energy level, resulting in the receiving chip being affected by stray light to have a high background noise, thus reducing a transceiver efficiency of the system.

In order to reduce the influence of stray light on the transceiver efficiency of the system and at the same time ensure a scanning efficiency, embodiments of the present disclosure also provides a lidar scanning method using the lidar system, including: controlling a light source of the lidar system to emit an area light beam of a preset shape.

In particular, the area light beam of the preset shape may be of any shape, so as to achieve area scanning by homogenizing and diffusing light form each light-emitting hole in the light source, compensate for dark zones caused by pixel defects, increase a detection range, and improve an imaging quality, and by making use of the preset shape, supplement distortions brought about by lens assemblies, to further reduce costs of the lens assemblies, so as to achieve random area scanning, and improve a transceiver matching efficiency.

In a feasible embodiment, if the area light beam of the preset shape is a block-shaped area light beam, a length M and a width N of the area light beam and a length m and a width n of a light beam detected by the receiving chip of the lidar system satisfy the following relationship: m/M≥1,n/N≥1; where, 1≤m≤8, 1≤n≤8.

In particular, a scanning area is improved by setting the block-shaped area light beam, thus improving the scanning efficiency; and the area of the area light beam is not larger than the area of the light beam detected by the receiving chip, by setting m/M≥1, m/M≥1, thus reducing signal light crosstalk at the end of the detector.

In a feasible embodiment, the light source of the lidar system is controlled to simultaneously emit at least two area light beams of the preset shape, a plurality of the area light beams of the preset shape being always non-adjacent to each other in the scanning process.

FIG. 43 shows a schematic diagram VI of a light source lit position in the lidar system provided by embodiments of the present disclosure. As shown in FIG. 43, two area light beams of a preset shape are set in the first row of the left half section and the twelfth row of the right half section, respectively, and are lit cyclically from top to bottom, so that the two light beams are never adjacent or intersecting with each other, thus avoiding areas susceptible to stray light and achieving lighting of areas with less stray light, which effectively reduces the influence of stray light on the system.

In a feasible embodiment, the light source of the lidar system is controlled to emit a single row/column of area light beam.

In particular, the scanning area is increased by lighting the whole row or column of area, and there is no crosstalk from light beams in other areas, to ensure a high scanning efficiency of the whole lidar system.

In a feasible embodiment, the light source of the lidar system is controlled to emit an area light beam of certain shape for eliminating a distortion of the emitting terminal lens assembly.

In particular, for a lidar system in which the emitting terminal lens assembly and the receiving terminal lens assembly are not co-distortion, it is conducive to realizing miniaturization of the lidar system and reducing the configuration cost of the system by emitting an area light beam of certain shape, for example, an area light beam of a triangular shape, in order to eliminate the influence of distortion by means of graphical transformation, and to avoid the installation of additional distortion-correcting equipment.

The lidar system of the present disclosure is described in detail below in conjunction with detailed embodiments, where the light sources are all VCSEL light sources and the receiving chips are all SPAD chips.

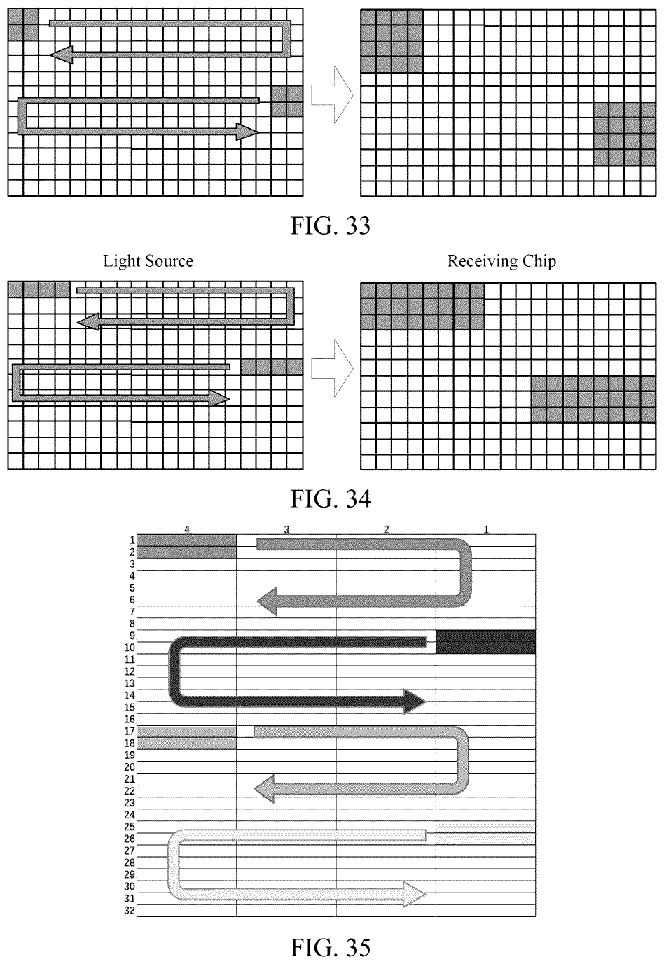

FIG. 33 shows a schematic diagram I of a lit relationship between a light source and a receiving chip in a lidar system provided by embodiments of the present disclosure. As shown in FIG. 33, the light source is provided with two blocks of non-adjacent square lit region m, light beams from which are diffused by the emitting terminal lens assembly in the lidar system and then hit on the target object after being homogenized and diffused by the microlens array, and the light beams reflected by the target object are then converged by the receiving terminal lens assembly and then detected and received by the receiving chip, to obtain two blocks of non-adjacent square lit area M corresponding to the lit regions of the light source; where, an area m of the lit region of the light source is smaller than an area M of the lit area of the receiving chip.

The light-emitting holes in the light source are arranged in multiple channels, with four rows of light-emitting holes provided in each channel, two adjacent rows of light-emitting holes are staggered closely arranged in a triangular distribution, each channel is composed of two regions, and the area of a single lit region is m.

Preferably, the light source is lit in a cyclic mode, i.e., a channel corresponding to the left edge section and the right edge section in the light source are simultaneously lit, and the remaining regions are lit sequentially in a cyclic mode, from left to right on the left section and right to left on the right section, as indicated by arrows in FIG. 33. At the same time, the consistency of lit position in the light source and the receiving chip is ensured, which is turned on and off at the same time, thus effectively reducing light crosstalk in different areas and ensuring a scanning accuracy.

An overall divergence angle of the lidar system is 126°*96°, and a size ratio of VCSEL light source to SPAD chip is 1:3.

The plurality of microlens units are randomized in central point arrangement in the horizontal direction, the central points are randomly arranged in the horizontal direction, and random range≤⅓*preset horizontal diameter D4.

The plurality of microlens units are randomized in central point arrangement in the vertical direction, the central points are randomly arranged in the vertical direction, and random range≤⅓*preset vertical diameter D6.

A horizontal field-of-view HFOV of the emitting terminal lens assembly, a horizontal radius of curvature R1 and a horizontal diameter D1 of the microlens unit satisfy: HFOV/(R1/D1) 16°.

Here, 0.005 mm≤D1≤1 mm; 0.1 mm≤R1≤20 mm.

The distortion of the emitting terminal lens assembly and the distortion of the receiving terminal lens assembly are the same, i.e., |Fθ_{TX}/Fθ_{RX}|=1. A matching efficiency between the receiving terminal and the emitting terminal is up to 98%.

A total length of the emitting terminal, L1, and a total length of the receiving terminal, L2, are equal to each other and both are 28 mm.

For the lidar system, a post-homogenization collimation degree α2/pre-homogenization collimation degree α1=2.8.

FIG. 34 shows a schematic diagram II of a lit relationship between a light source and a receiving chip in the lidar system provided by embodiments of the present disclosure. As shown in FIG. 34, the light source is provided with two blocks of non-adjacent rectangle lit regions n, light beams from which are diffused by the emitting terminal lens assembly in the lidar system and then hit on the target object after being homogenized and diffused by the microlens array, and the light beams reflected by the target object are then converged by the receiving terminal lens assembly and then detected and received by the receiving chip, to obtain two blocks of non-adjacent rectangle lit area N corresponding to the lit regions of the light source; where, an area n of the lit region of the light source is smaller than an area N of the lit area of the receiving chip.

The light-emitting holes in the light source are arranged in multiple channels, with two rows of light-emitting holes provided in each channel, two adjacent rows of light-emitting holes are staggered closely arranged in a triangular distribution, each channel is composed of two regions, and the area of a single lit region is n.

Preferably, the light source is lit in a cyclic mode, i.e., a channel corresponding to the left edge section and the right edge section in the light source are simultaneously lit, and the remaining areas are lit sequentially in a cyclic mode from top to bottom as indicated by arrows in FIG. 34. At the same time, the consistency of lit positions in the light source and lit positions in the receiving chip are ensured, which is turned on and off at the same time, thus effectively reducing light crosstalk in different areas and ensuring a scanning accuracy.

An overall divergence angle of the lidar system is 125.5° *96°, and a size ratio of VCSEL light source to SPAD chip is 1:3.

The plurality of microlens units are randomized in central point arrangement in the horizontal direction, the central points are randomly arranged in the horizontal direction, and random range≤⅓*preset horizontal diameter D4.

The plurality of microlens units are randomized in central point arrangement in the vertical direction, the central points are randomly arranged in the vertical direction, and random range≤⅓*preset vertical diameter D6.

A horizontal field-of-view HFOV of the emitting terminal lens assembly, a horizontal radius of curvature R1 and a horizontal diameter D1 of the microlens unit satisfy: HFOV/(R1/D1) 16°.

Here, 0.005 mm≤D1≤1 mm; 0.1 mm≤R1≤20 mm; HFOV=125.5°.

The distortion of the emitting terminal lens assembly and the distortion of the receiving terminal lens assembly are the same, i.e., |Fθ_{TX}/Fθ_{RX}|=1. A matching efficiency between the receiving terminal and the emitting terminal is up to 98%.

A total length of the emitting terminal, L1, and a total length of the receiving terminal, L2, are equal to each other and both are 30 mm.

For the lidar system, a post-homogenization collimation degree α2/pre-homogenization collimation degree α1=2.8.

FIG. 35 shows a schematic diagram I of a light source lit position in the lidar system provided by embodiments of the present disclosure. As shown in FIG. 35, the light source is provided with four blocks of non-adjacent lit regions, light beams from which are diffused by the emitting terminal lens assembly in the lidar system and then hit on the target object after being homogenized and diffused by the microlens array, and the light beams reflected by the target object are then converged by the receiving terminal lens assembly and then detected and received by the receiving chip, to obtain four blocks of non-adjacent lit areas corresponding to the lit regions of the light source; where, an area of the lit region of the light source is smaller than an area of the lit area of the receiving chip.

The light-emitting holes in the light source are arranged in 32 channels, with three rows of light-emitting holes provided in each channel, two adjacent rows of light-emitting holes are staggered closely arranged in a triangular distribution, and each channel is composed of four regions.

Preferably, the light source is lit in a cyclic mode, i.e., a channel corresponding to regions on both sections in the light source are simultaneously lit, and the remaining regions are lit sequentially in a cyclic mode, from left to right on the left section and from right to left on the right section, as indicated by arrows in FIG. 35. At the same time, the consistency of lit positions in the light source and lit positions in the receiving chip is ensured, which is turned on and off at the same time, thus effectively reducing light crosstalk in different areas and ensuring a scanning accuracy.

An overall divergence angle of the lidar system is 120° *90°, and a size ratio of VCSEL light source to SPAD chip is 1:3.

The plurality of microlens units are randomized in central point arrangement in the horizontal direction, the central points are randomly arranged in the horizontal direction, and random range≤⅓*preset horizontal diameter D4.

The plurality of microlens units are randomized in central point arrangement in the vertical direction, the central points are randomly arranged in the vertical direction, and random range≤⅓*preset vertical diameter D6.

A horizontal field-of-view HFOV of the emitting terminal lens assembly, a horizontal radius of curvature R1 and a horizontal diameter D1 of the microlens unit satisfy: HFOV/(R1/D1) 16°.

Here, 0.005 mm≤D1≤1 mm; 0.1 mm≤R1≤20 mm; HFOV=120°.

The distortion of the emitting terminal lens assembly and the distortion of the receiving terminal lens assembly are the same, i.e., |Fθ_{TX}/Fθ_{RX}|=1. A matching efficiency between the receiving terminal and the emitting terminal is up to 98%.

A total length of the emitting terminal, L1, and a total length of the receiving terminal, L2, are not equal to each other, the total length L1 is 22 mm and the total length L2 is 28 mm.

For the lidar system, a post-homogenization collimation degree α2/pre-homogenization collimation degree α1=3.2.

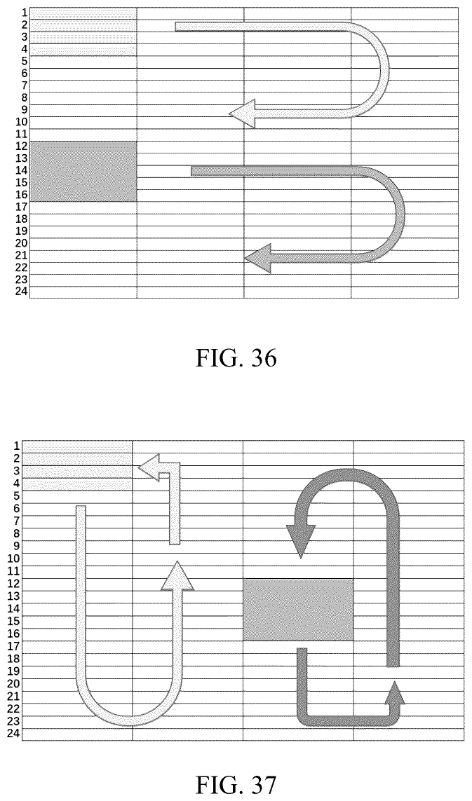

FIG. 36 shows a schematic diagram II of a light source lit position in the lidar system provided by embodiments of the present disclosure. As shown in FIG. 36, the light source is provided with two blocks of non-adjacent lit regions but in the same column, light beams from which are diffused by the emitting terminal lens assembly in the lidar system, and then hit on the target object after being homogenized and diffused by the microlens array, and the light beams reflected by the target object are then converged by the receiving terminal lens assembly and then detected and received by the receiving chip, to obtain two blocks of non-adjacent lit areas in the same column corresponding to the lit regions of the light source; where, an area of the lit region of the light source is smaller than an area of the lit area of the receiving chip.

The light-emitting holes in the light source are arranged in 24 channels, with two rows of light-emitting holes provided in each channel, two adjacent rows of light-emitting holes are staggered closely arranged in a triangular distribution, and each channel is composed of four regions.

Preferably, the light source is lit in a cyclic mode, i.e., a channel corresponding to unilateral regions in the light source are simultaneously lit, and the remaining regions are lit sequentially in a cyclic mode from left to right as indicated by arrows in FIG. 36. At the same time, the consistency of lit positions in the light source and the lit positions in the receiving chip is ensured, which is turned on and off at the same time, thus effectively reducing light crosstalk in different areas and ensuring a scanning accuracy.

An overall divergence angle of the lidar system is 128° *96°, and a size ratio of VCSEL light source to SPAD chip is 1:4.

The plurality of microlens units are randomized in central point arrangement in the horizontal direction, the central points are randomly arranged in the horizontal direction, and random range≤⅓*preset horizontal diameter D4.

The plurality of microlens units are randomized in central point arrangement in the vertical direction, the central points are randomly arranged in the vertical direction, and random range ⅓*preset vertical diameter D6.

A horizontal field-of-view HFOV of the emitting terminal lens assembly, a horizontal radius of curvature R1 and a horizontal diameter D1 of the microlens unit satisfy: HFOV/(R1/D1)≤16°.

Here, 0.005 mm≤D1≤1 mm; 0.1 mm≤R1≤20 mm; HFOV=128°.

The distortion of the emitting terminal lens assembly and the distortion of the receiving terminal lens assembly are the same to each other, i.e., |Fθ_{TX}/Fθ_{RX}|=1. A matching efficiency between the receiving terminal and the emitting terminal is up to 96%.

A total length of the emitting terminal, L1, and a total length of the receiving terminal, L2, are not equal to each other, the total length L1 is 24 mm and the total length L2 is 30 mm.

For the lidar system, a post-homogenization collimation degree α2/pre-homogenization collimation degree α1=3.5.

FIG. 37 shows a schematic diagram III of a light source lit position in the lidar system provided by embodiments of the present disclosure. As shown in FIG. 10, the light source is provided with two blocks of non-adjacent lit regions of different columns, light beams from which are diffused by the emitting terminal lens assembly in the lidar system, and then hit on the target object after being homogenized and diffused by the microlens array, and the light beams reflected by the target object are then converged by the receiving terminal lens assembly and then detected and received by the receiving chip, to obtain two blocks of non-adjacent lit areas of different columns corresponding to the lit regions of the light source; where, an area of the lit region of the light source is smaller than an area of the lit area of the receiving chip, and the microlens array is set to be affixed to the emitting terminal lens assembly to reduce a total length of the emitting terminal.

The light-emitting holes in the light source are arranged in 24 channels, with one row of light-emitting holes provided in each channel, and each channel is composed of two regions.

Preferably, the light source is lit in a cyclic mode, i.e., a channel corresponding to regions on two sections in the light source are simultaneously lit, and the remaining areas are lit sequentially in a cyclic mode from top to bottom as indicated by arrows in FIG. 37. At the same time, the consistency of lit positions in the light source and the lit positions in the receiving chip is ensured, which are turned on and off at the same time, thus effectively reducing light crosstalk in different areas and ensuring a scanning accuracy.

An overall divergence angle of the lidar system is 126° *96°, and a size ratio of VCSEL light source to SPAD chip is 1:3.

The plurality of microlens units are randomized in central point arrangement in the horizontal direction, the central points are randomly arranged in the horizontal direction, and random range≤⅓*preset horizontal diameter D4.

The plurality of microlens units are randomized in central point arrangement in the vertical direction, the central points are randomly arranged in the vertical direction, and random range≤⅓*preset vertical diameter D6.

A horizontal field-of-view HFOV of the emitting terminal lens assembly, a horizontal radius of curvature R1 and a horizontal diameter D1 of the microlens unit satisfy: HFOV/(R1/D1)≤16°.

Here, 0.005 mm≤D1≤1 mm; 0.1 mm≤R1≤20 mm; HFOV=126°.

The distortion of the emitting terminal lens assembly and the distortion of the receiving terminal lens assembly are the same, i.e., |Fθ_{TX}/Fθ_{RX}|=1. A matching efficiency between the receiving terminal and the emitting terminal is up to 99%.

The total length L1 of the emitting terminal and a total length L2 of the receiving terminal are not equal to each other, the total length L1 is 22 mm and the total length L2 is 28 mm.

For the lidar system, a post-homogenization collimation degree α2/pre-homogenization collimation degree α1=2.5.

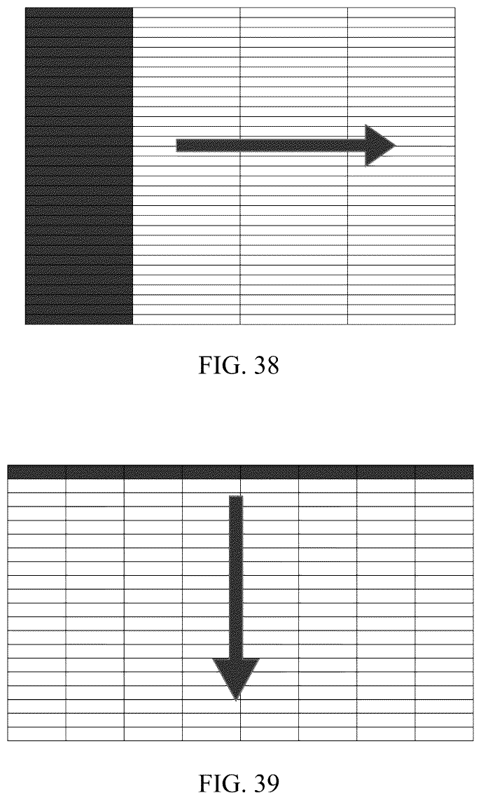

FIG. 38 shows a schematic diagram IV of a light source lit position in the lidar system provided by embodiments of the present disclosure. As shown in FIG. 38, the light source is provided with a single-column lit region, light beam from which is diffused by the emitting terminal lens assembly in the lidar system, and then hit on the target object after being homogenized and diffused by the microlens array, and the light beam reflected by the target object is then converged by the receiving terminal lens assembly and then detected and received by the receiving chip, to obtain a lit area of multiple columns corresponding to the lit region of the light source; where, an area of the lit region of the light source is smaller than an area of the lit area of the receiving chip.

The light-emitting holes in the light source are arranged in multiple channels, with two rows of light-emitting holes provided in each channel, and each row is composed of four columns of light-emitting holes, and one column of light sources are lit at a time.

Preferably, the light source is lit in a cyclic mode, and the remaining areas are lit, each time in a single column, sequentially in a cyclic mode from left to right as indicated by an arrow in FIG. 38.

An overall size ratio of VCSEL light source to SPAD chip of the lidar system is 1:2.1.

The microlens unit homogenizes the light beam in the horizontal direction, in a range of values satisfying: 2≤|radius of curvature R1 of a microlens unit/diameter D1 of the microlens unit|≤100, preferably, 5≤|radius of curvature R1 of a microlens unit/diameter D1 of the microlens unit|≤50.

The plurality of microlens units are randomized in thickness, random range≤⅓*preset microlens thickness d, preferably, random range≤⅕*preset microlens thickness d.

The plurality of microlens units are randomized in radius of curvature in the horizontal direction, with a random range of 1≤R1max/R1 min≤1.5.

The plurality of microlens units are randomized in radius of curvature in the vertical direction, with a random range of 1≤R2max/R2 min≤1.5.

The plurality of microlens units are randomized in central point arrangement in the horizontal direction, the central points are randomly arranged in the horizontal direction, and random range≤⅓*preset horizontal diameter D4.

The plurality of microlens units are randomized in central point arrangement in the vertical direction, the central points are randomly arranged in the vertical direction, and random range≤⅓*preset vertical diameter D6.

A horizontal field-of-view HFOV of the emitting terminal lens assembly, the horizontal radius of curvature R1 and the horizontal diameter D1 of a microlens unit satisfy: HFOV/(R1/D1) 16°.

Here, 0.005 mm≤D1≤1 mm; 0.1 mm≤R1≤20 mm; HFOV=126°.

For the lidar system, a post-homogenization collimation degree α2/pre-homogenization collimation degree α1=4.2.

FIG. 39 shows a schematic diagram V of a light source lit position in the lidar system provided by embodiments of the present disclosure. As shown in FIG. 39, the light source is provided with a single-row lit region, light beam from which is diffused by the emitting terminal lens assembly in the lidar system, and then hit on the target object after being homogenized and diffused by the microlens array, and the light beam reflected by the target object is then converged by the receiving terminal lens assembly and then detected and received by the receiving chip, to obtain a lit area of multiple rows corresponding to the lit region of the light source; where, an area of the lit region of the light source is smaller than an area of the lit area of the receiving chip.

The light-emitting holes in the light source are arranged in multiple channels, with three rows of light-emitting holes provided in each channel, and each row is composed of eight columns of light-emitting holes, and one row of light sources are lit at a time.

Preferably, the light source is lit in a cyclic mode, and the remaining regions are lit, each time in a single row, sequentially in a cyclic mode from top to bottom as indicated by an arrow in FIG. 39.

An overall size ratio of VCSEL light source to SPAD chip of the lidar system is 1:2.2.

The microlens unit homogenizes the light beam in the vertical direction, in a range of values satisfying: 2≤|radius of curvature R2 of a microlens unit/diameter D2 of the microlens unit|≤70, preferably, 5≤|radius of curvature R2 of a microlens unit/diameter D2 of the microlens unit|≤30.

The plurality of microlens units are randomized in thickness, random range≤⅓*preset microlens thickness d, preferably, random range ⅕*preset microlens thickness d.

The plurality of microlens units are randomized in radius of curvature in the horizontal direction, with a random range of 1≤R1max/R1 min≤1.5.

The plurality of microlens units are randomized in radius of curvature in the vertical direction, with a random range of 1≤R2max/R2 min≤1.5.

The plurality of microlens units are randomized in central point arrangement in the horizontal direction, the central points are randomly arranged in the horizontal direction, and random range≤⅓*preset horizontal diameter D4.

The plurality of microlens units are randomized in central point arrangement in the vertical direction, the central points are randomly arranged in the vertical direction, and random range≤⅓*preset vertical diameter D6.

A horizontal field-of-view HFOV of the emitting terminal lens assembly, a horizontal radius of curvature R1 and a horizontal diameter D1 of a microlens unit satisfy: HFOV/(R1/D1)≤16°.

Here, 0.005 mm≤D1≤1 mm; 0.1 mm≤R1≤20 mm; HFOV=96°.

For the lidar system, a post-homogenization collimation degree α2/pre-homogenization collimation degree α1=5.

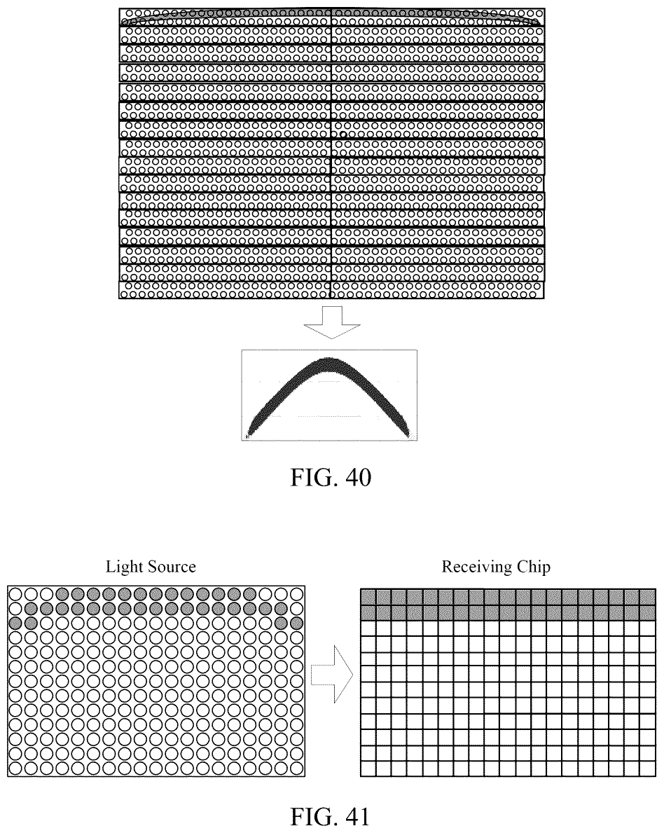

FIG. 40 shows a schematic diagram of a relationship between a light source lit position and a light signal received by a receiving chip in the lidar system provided by embodiments of the present disclosure. As shown in FIG. 40, the light source is provided with an arc-shaped lit region, which is collimated by the emitting terminal lens assembly in the lidar system, and then hit on the target object after being homogenized and diffused by the microlens array, and the light beam reflected by the target object is then converged by the receiving terminal lens assembly and then detected and received by the receiving chip, to obtain an arc-shaped light signal corresponding to the lit region of the light source.

The light-emitting holes in the light source are arranged in multiple channels, with two rows of light-emitting holes provided in each channel, two adjacent rows of light-emitting holes are staggered closely arranged in a triangular distribution, and each channel is composed of one region.

A size ratio of VCSEL light source to SPAD chip of the lidar system is 1:3.

The plurality of microlens units are randomized in thickness, random range≤⅓*preset microlens thickness d, preferably, random range≤⅕*preset microlens thickness d.

The plurality of microlens units are randomized in radius of curvature in the horizontal direction, with a random range of 1≤R1max/R1 min≤1.5.

The plurality of microlens units are randomized in radius of curvature in the vertical direction, with a random range of 1≤R2max/R2 min≤1.5.

The plurality of microlens units are randomized in central point arrangement in the horizontal direction, the central points are randomly arranged in the horizontal direction, and random range≤⅓*preset horizontal diameter D4.

The plurality of microlens units are randomized in central point arrangement in the vertical direction, the central points are randomly arranged in the vertical direction, and random range≤⅓*preset vertical diameter D6.

A horizontal field-of-view HFOV of the emitting terminal lens assembly, a horizontal radius of curvature R1 and a horizontal diameter D1 of the microlens unit satisfy: HFOV/(R1/D1) 16°.

Here, 0.005 mm≤D1≤1 mm; 0.1 mm≤R1≤20 mm; HFOV=124°.

The distortion of the emitting terminal lens assembly and the distortion of the receiving terminal lens assembly are not the same, |Fθ_{TX}/Fθ_{Rx}|=1:1.05.

For the lidar system, a post-homogenization collimation degree α2/pre-homogenization collimation degree α1=3.1.

FIG. 41 shows a schematic diagram of a corresponding relationship between a light source lit region and a receiving chip lit area in the lidar system provided by embodiments of the present disclosure. As shown in FIG. 41, the light source may be provided with a lit region of an arbitrary shape, such as an arc-shaped lit region with unlit dark zones between adjacent light-emitting holes, light beam from which is collimated by the emitting terminal lens assembly in the lidar system, and then hit on the target object after being homogenized and diffused by the microlens array, and the light beam reflected by the target object is then converged by the receiving terminal lens assembly and then detected and received by the receiving chip, to obtain an arc-shaped lit area corresponding to the lit region of the light source, and there is no dark zone between two adjacent light-emitting points in the arc-shaped lit area of the receiving chip.

The light-emitting holes in the light source are arranged in multiple channels, each of which may be lit arbitrarily, and the shape of the lit region may match distortion at the emitting terminal.

A size ratio of VCSEL light source to SPAD chip of the lidar system is 1:1.5.

The plurality of microlens units are randomized in thickness, random range≤⅓*preset microlens thickness d, preferably, random range≤⅕*preset microlens thickness d.

The plurality of microlens units are randomized in radius of curvature in the horizontal direction, with a random range of 1≤R1max/R1 min≤1.5.

The plurality of microlens units are randomized in radius of curvature in the vertical direction, with a random range of 1≤R2max/R2 min≤1.5.

The plurality of microlens units are randomized in central point arrangement in the horizontal direction, the central points are randomly arranged in the horizontal direction, and random range≤⅓*preset horizontal diameter D4.

The plurality of microlens units are randomized in central point arrangement in the vertical direction, the central points are randomly arranged in the vertical direction, and random range≤⅓*preset vertical diameter D6.

A horizontal field-of-view HFOV of the emitting terminal lens assembly, a horizontal radius of curvature R1 and a horizontal diameter D1 of the microlens unit satisfy: HFOV/(R1/D1)≤16°.

Here, 0.005 mm≤D1≤1 mm; 0.1 mm≤R1≤20 mm; HFOV=124°.

The distortion of the emitting terminal lens assembly and the distortion of the receiving terminal lens assembly are not the same, |Fθ_{TX}/Fθ_{RX}|=1:1.05.

The lidar system has a post-homogenization collimation degree α2/pre-homogenization collimation degree α1=3.1.

Embodiments of the present disclosure propose an optical device for homogenizing and diffusing light.

A detailed application scenario of the optical device for homogenizing and diffusing light of embodiments of the present disclosure is as follows.

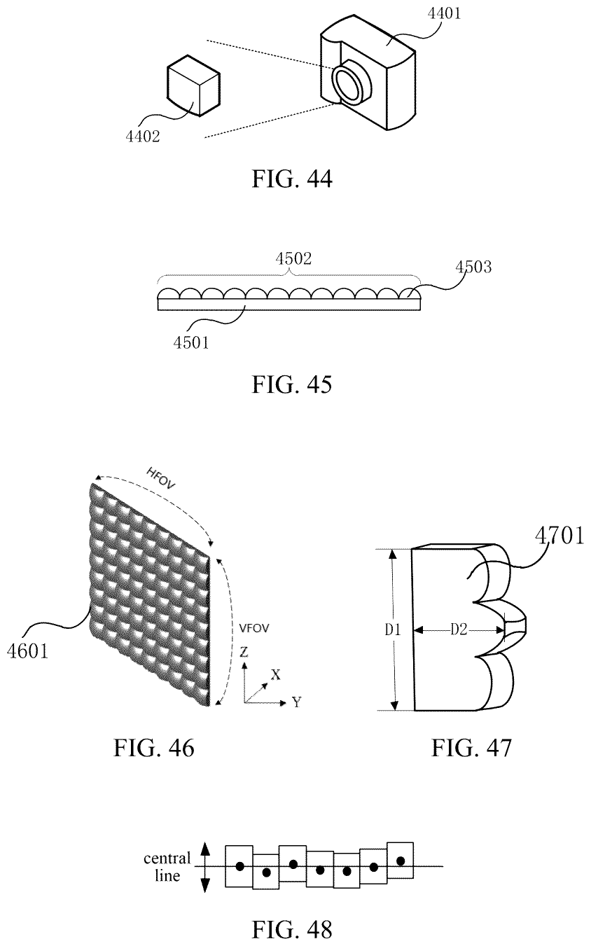

FIG. 44 shows a schematic diagram of an application scenario of an optical device for homogenizing and diffusing light provided by embodiments of the present disclosure. As shown in FIG. 44, a lidar 4401 containing the optical device for homogenizing and diffusing light detects a target object 4402, a light source in the lidar 4401 emits a light beam, which is irradiated to a surface of the target object 4402 after being homogenized and diffused by the optical device for homogenizing and diffusing light, the light beam is reflected by the target object 4402 and then is received by a beam receiving device of the lidar 4401, so as to obtain a reflection signal of the target object 4402, thereby determining information associated with the target object 4402 based on the reflection signal.

FIG. 45 shows a schematic structure diagram I of an optical device for homogenizing and diffusing light provided by embodiments of the present disclosure. As shown in FIG. 45, the optical device for homogenizing and diffusing light includes: a substrate 4501; and at least one microlens array 4502, which includes a plurality of microlens units 4503 disposed on the substrate 4501. The plurality of microlens units 4503 are arranged and set correspondingly based on a homogenizing and diffusing direction of to-be-processed light source.

In particular, the microlens array is formed by etching or molding on the substrate, and each microlens unit 4503 in the microlens array may be the same as or different from the other microlens units 4503; a shape of each microlens unit 4503 may have a regular shape or a non-regular shape; and the microlens array 4502 formed by the microlens units 4503 may have a single surface for homogenizing and diffusing, or may have double-surface for homogenizing and diffusing.

In a feasible embodiment, when the homogenizing and diffusing direction of light beam from the to-be-processed light source is horizontal, the microlens array includes a single-row microlens units arranged in the same direction horizontally, and a horizontal radius of curvature R1 and a horizontal diameter D1 of the single-row microlens units may satisfy the following relationship: 2≤|R1/D1|≤100; or, 5≤|R1/D1|≤50.

In particular, this relationship enables the microlens units to be homogenized in the horizontal direction, which facilitates the diffusion and homogenization on light beam in the horizontal direction.

In a feasible embodiment, when the homogenizing and diffusing direction of light beam from the to-be-processed light source is vertical, the microlens array includes a single-row microlens units arranged in the same direction vertically, and a vertical radius of curvature R2 and a vertical diameter D2 of the single-row microlens units may satisfy the following relationship: 2≤|R2/D2|≤70; or, 5≤|R2/D2|≤30.

In particular, this relationship enables the microlens units to be homogenized in the vertical direction, which facilitates the diffusion and homogenization on light beam in the vertical direction.

In a feasible embodiment, when the homogenizing and diffusing direction of light beam from the to-be-processed light source includes both the horizontal direction and the vertical direction, the microlens array is at least provided with a single-row microlens units arranged in the same direction horizontally and single-row microlens units arranged in the same direction vertically, and an array composed of such single-row microlens units arranged in the same direction horizontally and an array composed of such single-row microlens units arranged in the same direction vertically are arranged orthogonally to each other; where, the horizontal radius of curvature R1 and the horizontal diameter D1 of the single-row microlens units arranged in the same direction horizontally may satisfy the following relationship: 2≤|R1/D1|≤100; or, 5≤|R1/D1|≤50; and the vertical radius of curvature R2 and the vertical diameter D2 of the single-row microlens units arranged in the same direction vertically may satisfy the following relationship: 2≤|R2/D2|≤70; or, 5≤|R2/D2|≤30.

In particular, since both horizontal and vertical homogenization designs are available, it is possible to achieve diffusion and homogenization in both directions at the same time. It should be noted that the degree of homogenization in the horizontal and vertical directions may be the same or different, and diffusion in the two directions is not symmetrical and needs to be set correspondingly according to actual diffusion needs.

In another preferable implementation, the arrays of microlens units in the two directions may be disposed affixed to each other side-by-side or disposed non-affixed side-by-side.

FIG. 46 shows a schematic structure diagram II of an optical device for homogenizing and diffusing light provided by embodiments of the present disclosure. FIG. 47 shows a schematic diagram of a partial structure of a block microlens unit provided by embodiments of the present disclosure. As shown in FIG. 46 and FIG. 47, a further possible implementation is that the microlens array 4601 further includes a plurality of block microlens units 4701;

where, a horizontal radius of curvature R1 and a horizontal diameter D1 of a block microlens unit may satisfy the following relationship: 2≤|R1/D1|≤100; or, 5≤|R1/D1|≤50; and/or a vertical radius of curvature R2 and a vertical diameter D2 of a block microlens unit may satisfy the following relationship: 2≤|R2/D2|≤70; or, 5≤|R2/D2|≤30.

In particular, the arrays of single-row microlens units in the horizontal direction and the vertical direction are replaced with the block microlens unit array having both radius of curvature and diameter characteristics in both the horizontal and vertical directions, to realize the function of homogenization and diffusion; where, the block shape includes a regular square block shape, a regular semi-circular spherical block shape, or an arbitrary irregular block shape structure.

In a feasible embodiment, thicknesses of the microlens units are thickness random values, and a magnitude of variation d0 of a thickness random value and a preset microlens unit thickness d may satisfy the following relationship: d0≤⅓*d; or, d0≤⅕*d.

In particular, the thickness random values make the thicknesses of multiple neighboring microlens units not uniform therebetween, but fluctuate within a certain range, thus avoiding the influence of diffraction due to uniformity of thickness and substantially suppressing a diffraction effect.

In a feasible embodiment, the horizontal radii of curvature of the microlens units are horizontal radius of curvature random values, and a maximum horizontal radius of curvature random value R1max and a minimum horizontal radius of curvature random value R1 min in the horizontal radius of curvature random values may satisfy the following relationship: |R1max/R1 min|≤1.5.

In a feasible embodiment, the vertical radii of curvature of the microlens units are vertical radius of curvature random values, and a maximum vertical radius of curvature random value R2max and a minimum vertical radius of curvature random value R2 min in the vertical radius of curvature random values may satisfy the following relationship: |R2max/R2 min|≤1.5.

In particular, the radii of curvature in both the horizontal direction and the vertical direction are set to random values that fluctuate within a certain range, thus avoiding the influence of diffraction due to uniformity of radius of curvature and substantially suppressing the diffraction effect.

FIG. 48 shows a schematic diagram of horizontal positions of central points of an arrangement of a plurality of microlens units provided by embodiments of the present disclosure. As shown in FIG. 48, central points of horizontal diameters of the plurality of microlens units may not be in the same plane, and a height difference D3 between a central point of the horizontal diameter and a central point of a preset microlens unit diameter, and the preset microlens unit diameter D4 in the horizontal direction, may satisfy the following relationship: |D3|≤⅓*D4.

In a feasible embodiment, central points of vertical diameters of the plurality of microlens units may not be in the same plane, and a height difference D5 between a central point of the vertical diameter and a central point of a preset microlens unit diameter, and the preset microlens unit diameter D6 in the vertical direction, may satisfy the following relationship: |D51≤⅓*D6.

In particular, the horizontal central points and the vertical central points of the microlens array are arranged randomly, which ensures a light-homogenizing and diffusion effect, and is conducive to eliminating diffraction.

The optical device for homogenizing and diffusing light provided in the present embodiment, by providing the microlens units arranged on the substrate based on the homogenizing and diffusing direction of the to-be-processed light source, to obtain a microlens array with a specific homogenizing and diffusing direction, thereby realizing the function of homogenization and diffusion of the to-be-processed light source on a specific light-emitting region, to obtain a light-emitting area of high homogeneity, and can realize illumination of a detection area without dark zones, when applied to a scanning detection apparatus.

Embodiments of the present disclosure also provide an optical system for homogenizing and diffusing light, including: a light source; and an optical device for homogenizing and diffusing light, where, a light beam emitted by the light source is processed by the optical device for homogenizing and diffusing light to obtain a homogenized and diffused beam.

In particular, the optical device for homogenizing and diffusing light is applied to the optical system for homogenizing and diffusing light to homogenize and diffuse the light beam emitted by the light source, so as to expand an irradiation area of the light source on a to-be-detected area while retaining emitted energy of the light source.

In a feasible embodiment, an emitting terminal lens assembly is also provided, between the light source and the optical device for homogenizing and diffusing light, the light source is set to be non-affixed to the emitting terminal lens assembly, and the emitting terminal lens assembly and the optical device for homogenizing and diffusing light are set to be affixed or non-affixed to each other.

Preferably, when the emitting terminal lens assembly and the optical device for homogenizing and diffusing light are set to be affixed to each other, a curvature of a last surface of the emitting terminal lens assembly coincides with a curvature of an affixing surface of the optical device for homogenizing and diffusing light.

In particular, when the emitting terminal lens assembly and the optical device for homogenizing and diffusing light are set to be affixed to each other, it can effectively shorten a total length of the system, which is conducive to the miniaturization of the system, in addition, in the affixed setup, the curvature of a second side of the last lens in the emitting terminal lens assembly may coincide with the affixed optical device for homogenizing and diffusing light, to improve a match degree between the emitting terminal lens assembly and the optical device for homogenizing and diffusing light, and the curvatures may be any one of convex, concave, or planar.

Preferably, since an optical window for protecting the emitting terminal lens assembly is usually provided on the outside of the emitting terminal lens assembly, the optical device for homogenizing and diffusing light may also be affixed to the optical window of the emitting terminal lens assembly, or the optical device for homogenizing and diffusing light may also be integrally molded and processed with the optical window to shorten the length of the system.

In a feasible embodiment, a horizontal field-of-view HFOV of the emitting terminal lens assembly, a horizontal radius of curvature R1 and a horizontal diameter D1 of a microlens unit may satisfy the following dark-zone compensation relationship: HFOV/(R1/D1)≤30; or, HFOV/(R1/D1)≤12.

In particular, the setting parameters enable the light beam to obtain a better light-homogenizing and diffusion effect in the horizontal direction, which is conducive to compensating for dark zones.

In a feasible embodiment, a pre-homogenization collimation degree α1 and a post-homogenization collimation degree α2 of the light source, the horizontal field-of-view HFOV of the emitting terminal lens assembly, a focal length F_{T} of the emitting terminal lens assembly, the number of light-emitting holes C in a channel of a single row in the horizontal direction, and a diameter Le of a single light-emitting hole of the light source may satisfy the following irradiation area relationship: 1≤α2/α1≤F_{T}*2 tan(HFOV/2)/C/Le; where, α1>0, 1≤F_{T}*2 tan(HFOV/2)/C/Le≤35; or, F_{T}*tan(HFOV/2)/C/Le≤α2/α1≤F_{T}*2 tan(HFOV/2)/C/Le.

In particular, the setting parameters enable each light source to be fully and effectively used in the horizontal direction, avoiding energy loss and thus enhancing a light-homogenizing and diffusion effect.

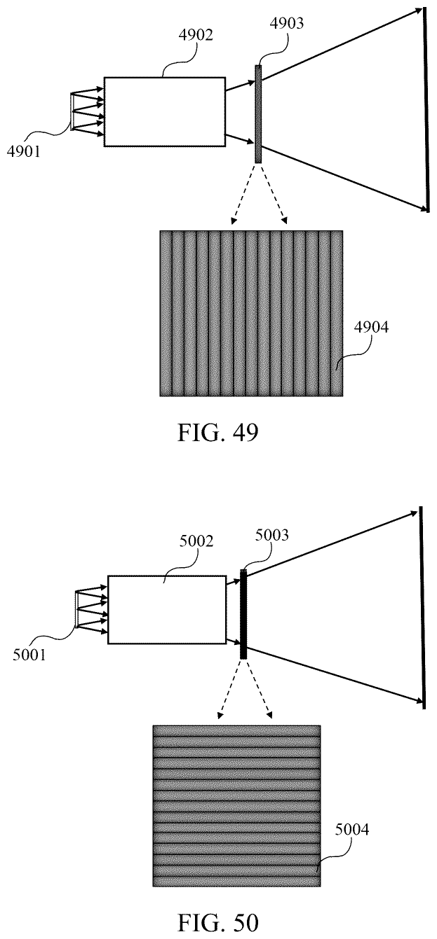

FIG. 49 shows a schematic structure diagram I of an optical system for homogenizing and diffusing light provided by embodiments of the present disclosure. As shown in FIG. 49, the optical system for homogenizing and diffusing light includes a light source 4901, an emitting terminal lens assembly 4902, and an optical device 4903 for homogenizing and diffusing light containing a plurality of single-row microlens units 4904 horizontally arranged in the same direction. Dashed arrows in the figure indicate that the sideways-displayed optical device 4903 for homogenizing and diffusing light is flipped over to a frontal-displayed view.

Here, radii of curvature of the plurality of single-row microlens units 4904 horizontally arranged in the same direction may be the same or different, and diameters of the plurality of single-row microlens units 4904 horizontally arranged in the same direction may be the same or different.

In particular, the optical device for homogenizing and diffusing light is configured to homogenize the light beam in the horizontal direction, 2≤|radius of curvature R1 of a microlens unit/diameter D1 of the microlens unit|≤100, preferably, 5≤|radius of curvature R1 of a microlens unit/diameter D1 of the microlens unit|≤50.

The plurality of single-row microlens units horizontally arranged in the same direction is randomized in thickness, random range≤⅓*preset microlens thickness d, preferably, random range≤⅕*preset microlens thickness d.

The plurality of single-row microlens units horizontally arranged in the same direction may be randomized in radius of curvature in the horizontal direction, with a random range of 0.5≤|R1ₘₐₓ/R1ₘᵢₙ|≤1.5.

The plurality of single-row microlens units horizontally arranged in the same direction may be randomized in central point arrangement in the horizontal direction, the central points are randomly arranged in the horizontal direction, random range≤⅓*preset microlens unit diameter D4.

A horizontal field-of-view HFOV of the emitting terminal lens assembly, the horizontal radius of curvature R1 and the horizontal diameter D1 of the microlens unit may satisfy: HFOV/(R1/D1)≤16.

Here, 0.005 mm≤D1≤1 mm; 0.1 mm≤R1≤20 mm; and the HFOV is 96°.

For the optical system for homogenizing and diffusing light, a post-homogenization collimation degree α2/pre-homogenization collimation degree α1=3.2. A focal length F_{T} of the emitting terminal lens assembly=2.2 mm; the number of light-emitting holes C in a single row channel in the horizontal direction=48; a diameter Le of a single light-emitting aperture of the light source=22 μm; and F_{T}*2 tan(HFOV/2)/C/Le=4.628.

The optical system for homogenizing and diffusing light provided in the present embodiment, in which a light beam emitted by the light source is collimated and shaped by the emitting terminal lens assembly, and then the light beam of the light source in the horizontal direction is homogenized and diffused by the optical device for homogenizing and diffusing light, so as to realize expansion of the irradiation area, compensate for dark zones caused by pixel defects, increase a detection range, and improve an imaging quality.

FIG. 50 shows a schematic structure diagram II of an optical system for homogenizing and diffusing light provided by embodiments of the present disclosure. As shown in FIG. 50, the optical system for homogenizing and diffusing light includes a light source 5001, an emitting terminal lens assembly 5002, and an optical device 5003 for homogenizing and diffusing light, the optical device 5003 contains a plurality of single-row microlens units 5004 vertically arranged in the same direction. Dashed arrows in the figure indicate that the sideways-displayed optical device 5003 for homogenizing and diffusing light is flipped over to a frontal-displayed view.

Here, radii of curvature of the plurality of single-row microlens units 5004 vertically arranged in the same direction may be the same or different, and diameters of the plurality of single-row microlens units 5004 vertically arranged in the same direction may be the same or different.

In particular, the optical device for homogenizing and diffusing light may be configured to homogenize the light beam in the vertical direction, 2≤|radius of curvature R2 of a microlens unit/diameter D2 of the microlens unit|≤70, preferably, 5≤|radius of curvature R2 of a microlens unit/diameter D2 of the microlens unit|≤30.

The plurality of single-row microlens units vertically arranged in the same direction is randomized in thickness, random range≤⅓*preset microlens thickness d, preferably, random range≤⅕*preset microlens thickness d.

The plurality of single-row microlens units vertically arranged in the same direction may be randomized in radius of curvature in the vertical direction, with a random range of 0.5≤|R2ₘₐₓ/R2ₘᵢₙ|≤1.5.

The plurality of single-row microlens units horizontally arranged in the same direction may be randomized in central point arrangement in the vertical direction, the central points are randomly arranged in the vertical direction, random range≤⅓*preset microlens unit diameter D6.

A vertical field-of-view VFOV of the emitting terminal lens assembly, the vertical radius of curvature R2 and the vertical diameter D2 of the microlens unit may satisfy: VFOV/(R1/D1)≤30.

Here, 0.005 mm≤D2≤1 mm; 0.1 mm≤R2≤20 mm; and the VFOV is 96°.

For the optical system for homogenizing and diffusing light, a post-homogenization collimation degree α2/pre-homogenization collimation degree α1=4. A focal length F_{T} of the emitting terminal lens assembly=2.2 mm; the number of light-emitting holes C in a single column channel in the vertical direction=48; a diameter Le of a single light-emitting hole of the light source=22 μm; and F_{T}*2 tan(VFOV/2)/C/Le=4.628.

The optical system for homogenizing and diffusing light provided in the present embodiment, in which a light beam emitted by the light source is collimated and shaped by the emitting terminal lens assembly, and then the light beam of the light source in the vertical direction is homogenized and diffused by the optical device for homogenizing and diffusing light, so as to realize expansion of the irradiation area, compensate for dark zones caused by pixel defects, increase the detection range, and improve the imaging quality.

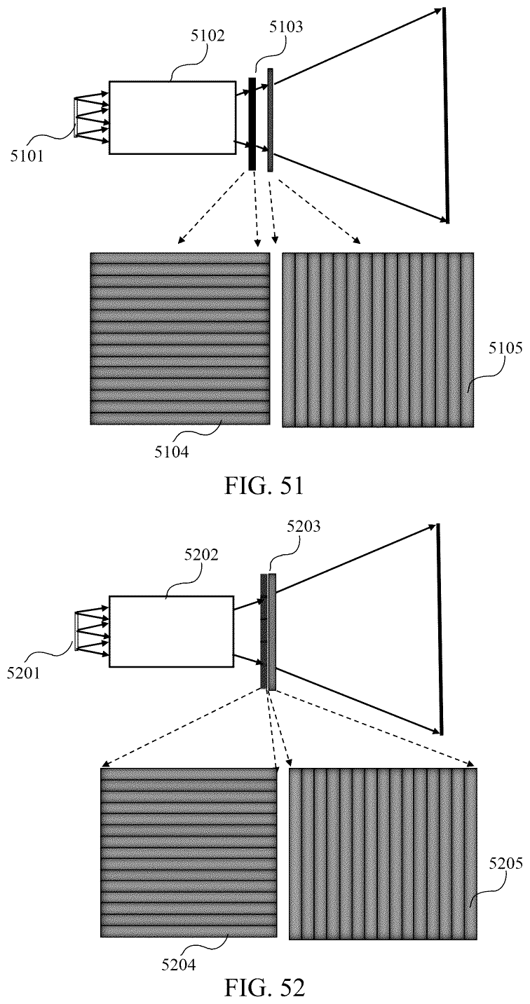

FIG. 51 shows a schematic structure diagram III an optical system for homogenizing and diffusing light provided by embodiments of the present disclosure. As shown in FIG. 51, the optical system for homogenizing and diffusing light includes a light source 5101, an emitting terminal lens assembly 5102, and an optical device 5103 for homogenizing and diffusing light, the optical device 5103 contains a plurality of single-row microlens units 5104 horizontally arranged in the same direction and single-row microlens units 5105 vertically arranged in the same direction. Dashed arrows in the figure indicate that the sideways-displayed optical device 5103 for homogenizing and diffusing light is flipped over to a frontal-displayed view.

Here, radii of curvature of the plurality of single-row microlens units 5104 horizontally arranged in the same direction and single-row microlens units 5105 vertically arranged in the same direction may be the same or different; diameters of the plurality of single-row microlens units 5104 horizontally arranged in the same direction and single-row microlens units 5105 vertically arranged in the same direction may be the same or different; and the plurality of single-row microlens units 5104 horizontally arranged in the same direction and single-row microlens units 5105 vertically arranged in the same direction are set to be non-affixed to each other but spaced to each other, and are perpendicular to each other to jointly form a double-row orthogonal microlens array.

In particular, the optical device for homogenizing and diffusing light may be configured to homogenize the light beam in both the horizontal direction and the vertical direction simultaneously.

In the horizontal direction: 2≤|radius of curvature R1 of a microlens unit/diameter D1 of the microlens unit|≤100, preferably, 5≤|radius of curvature R1 of a microlens unit/diameter D1 of the microlens unit|≤50.

In the vertical direction, 2≤|radius of curvature R2 of a microlens unit/diameter D2 of the microlens unit|≤70, preferably, 5≤|radius of curvature R2 of a microlens unit/diameter D2 of the microlens unit|≤30.

The plurality of single-row microlens units horizontally arranged in the same direction are randomized in thickness, random range≤⅓*preset microlens thickness d, preferably, random range≤⅕*preset microlens thickness d.

The plurality of single-row microlens units horizontally arranged in the same direction are randomized in radius of curvature in the horizontal direction, with a random range of 0.5≤R1max/R1 min≤1.5.

The plurality of single-row microlens units horizontally arranged in the same direction are randomized in radius of curvature in the vertical direction, with a random range of 0.5≤R2max/R2 min≤1.5.

The plurality of single-row microlens units horizontally arranged in the same direction are randomized in central point arrangement in the horizontal direction, the central points are randomly arranged in the horizontal direction, random range≤⅓*preset microlens unit diameter D4.

The plurality of single-row microlens units horizontally arranged in the same direction are randomized in central point arrangement in the vertical direction, the central points are randomly arranged in the vertical direction, random range≤⅓*preset microlens unit diameter D6.

A horizontal field-of-view HFOV of the emitting terminal lens assembly, the horizontal radius of curvature R1 and the horizontal diameter D1 of the microlens unit satisfy: HFOV/(R1/D1)≤16.

Here, 0.005 mm≤D1≤1 mm; 0.1 mm≤R1≤20 mm; the horizontal field-of-view HFOV of the emitting terminal lens assembly is 126°, and a vertical field-of-view VFOV of the emitting terminal lens assembly is 96°.

For the optical system for homogenizing and diffusing light, a post-homogenization collimation degree α2/pre-homogenization collimation degree α1=3.2. A focal length F_{T} of the emitting terminal lens assembly=2 mm; the number of light-emitting holes C in a single row channel in the horizontal direction=60; a diameter Le of a single light-emitting hole of the light source=30 μm; and F_{T}*2 tan(HFOV/2)/C/Le=4.361.

The optical system for homogenizing and diffusing light provided in the present embodiment, in which a light beam emitted by the light source is collimated and shaped by the emitting terminal lens assembly, and then the light beam of the light source in both the horizontal direction and the vertical direction is homogenized and diffused by the optical device for homogenizing and diffusing light of the double-row orthogonal microlens array, so as to realize expansion of the irradiation area, compensate for dark zones caused by pixel defects, increase the detection range, and improve the imaging quality.

FIG. 52 shows a schematic structure diagram IV of an optical system for homogenizing and diffusing light provided by embodiments of the present disclosure. As shown in FIG. 52, the optical system for homogenizing and diffusing light includes a light source 5201, an emitting terminal lens assembly 5202, and an optical device 5203 for homogenizing and diffusing light containing a plurality of single-row microlens units 5204 horizontally arranged in the same direction and single-row microlens units 5205 vertically arranged in the same direction. Dashed arrows in the figure indicate that the sideways-displayed optical device 5203 for homogenizing and diffusing light is flipped over to a frontal-displayed view.

Detailed implementation of the optical system for homogenizing and diffusing light in the present embodiment can be referred to in the above system embodiment in FIG. 51, the difference is only that, in the present embodiment, the plurality of single-row microlens units 5204 horizontally arranged in the same direction and single-row microlens units 5205 vertically arranged in the same direction are affixed to each other to form the optical device 5203 for homogenizing and diffusing light. In addition, in the parameters, the HFOV is 110°, the VFOV is 96°, and for the optical system for homogenizing and diffusing light, a post-homogenization collimation degree α2/pre-homogenization collimation degree α1=3. A focal length F_{T} of the emitting terminal lens assembly=2 mm; the number of light-emitting holes C in a single row channel in the horizontal direction=60; a diameter Le of a single light-emitting hole of the light source=26 μm; and F_{T}*2 tan(HFOV/2)/C/Le=3.662.

The rest of the implementation principles and technical effects are similar, and will be omitted herein in the present embodiment.

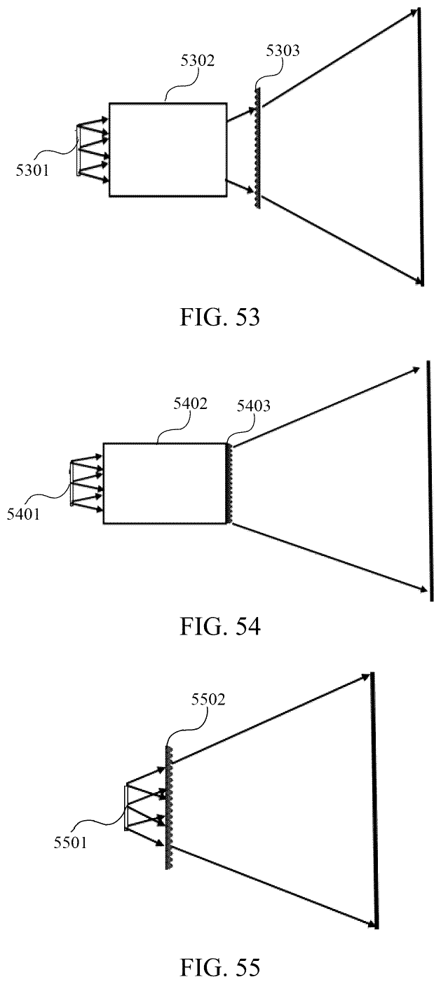

FIG. 53 shows a schematic structure diagram V of an optical system for homogenizing and diffusing light provided by embodiments of the present disclosure. As shown in FIG. 53, the optical system for homogenizing and diffusing light includes a light source 5301, an emitting terminal lens assembly 5302, and an optical device 5303 for homogenizing and diffusing light containing a plurality of block-shaped microlens units.

Here, one surface of the block-shaped microlens unit is a microlens array and the other surface has no curvature, radii of curvature of the plurality of block-shaped microlens units may be the same or different, diameters of the plurality of block-shaped microlens units may be the same or different, and individual block-shaped microlens units are of the same size and dimensions.

In particular, the optical device for homogenizing and diffusing light is configured to homogenize the light beam in both the horizontal direction and the vertical direction simultaneously.

In the horizontal direction: 2≤|radius of curvature R1 of a microlens unit/diameter D1 of the microlens unit|≤100, preferably, 5≤|radius of curvature R1 of a microlens unit/diameter D1 of the microlens unit|≤50.

In the vertical direction, 2≤|radius of curvature R2 of a microlens unit/diameter D2 of the microlens unit|≤70, preferably, 5≤|radius of curvature R2 of a microlens unit/diameter D2 of the microlens unit|≤30.

The plurality of block-shaped microlens units are randomized in thickness, random range≤⅓*preset microlens unit thickness d, preferably, random range≤⅕*preset microlens unit thickness d.

The plurality of block-shaped microlens units are randomized in radius of curvature in the horizontal direction, with a random range of 0.5≤R1max/R1 min≤1.5.

The plurality of block-shaped microlens units are randomized in radius of curvature in the vertical direction, with a random range of 0.5≤R2max/R2 min≤1.5.

The plurality of block-shaped microlens units are randomized in central point arrangement in the horizontal direction, the central points are randomly arranged in the horizontal direction, random range≤⅓*preset microlens unit diameter D4.

The plurality of block-shaped microlens units are randomized in central point arrangement in the vertical direction, the central points are randomly arranged in the vertical direction, random range≤⅓*preset microlens unit diameter D6.

A horizontal field-of-view HFOV of the emitting terminal lens assembly, the horizontal radius of curvature R1 and the horizontal diameter D1 of a microlens unit satisfy: HFOV/(R1/D1)≤16.

Here, 0.005 mm≤D1≤1 mm; 0.1 mm≤R1≤20 mm; the HFOV is 120°, and a VFOV is 96°.

For the optical system for homogenizing and diffusing light, a post-homogenization collimation degree α2/pre-homogenization collimation degree α1=4. A focal length F_{T} of the emitting terminal lens assembly=2.8 mm; the number of light-emitting holes C in a single row channel in the horizontal direction=68; a diameter Le of a single light-emitting hole of the light source=33 μm; and F_{T}*2 tan(HFOV/2)/C/Le=4.322.

Individual block-shaped microlens units may be of multilayer structure, and the block-shaped microlens unit structure may be a symmetrical structure or an asymmetrical structure. A length in a short-axis direction of the individual block-shaped microlens units is random, random range≤½*preset microlens unit thickness d.

The optical system for homogenizing and diffusing light provided in the present embodiment, in which a light beam emitted by the light source is collimated and shaped by the emitting terminal lens assembly, and then the light beam of the light source in both the horizontal direction and the vertical direction is homogenized and diffused by the optical device for homogenizing and diffusing light by the block-shaped microlens units, so as to realize expansion of the irradiation area, compensate for dark zones caused by pixel defects, increase the detection range, and improve the imaging quality. Here, the optical device for homogenizing and diffusing light is not affixed to the emitting terminal lens assembly and is placed behind the emitting terminal lens assembly, but may also be affixed to a protective glass of an outer cover of the emitting terminal lens assembly, or etched on a side of the protective glass close to the light source, which is conducive to miniaturization of the overall apparatus.

FIG. 54 shows a schematic structure diagram VI of an optical system for homogenizing and diffusing light provided by embodiments of the present disclosure. As shown in FIG. 54, the optical system for homogenizing and diffusing light includes a light source 5401, an emitting terminal lens assembly 5402, and an optical device 5403 for homogenizing and diffusing light containing a plurality of block-shaped microlens units.

Detailed implementation of the optical system for homogenizing and diffusing light in the present embodiment can be referred to in the above system embodiment in FIG. 53, the difference is only that, in the present embodiment, the optical device 5403 for homogenizing and diffusing light composed of block-shaped microlens units is affixed to the emitting terminal lens assembly 5402, to control a total length of the system and ensure miniaturization of the system, and a curvature of the optical device 5403 for homogenizing and diffusing light is the same as the curvature of the affixed emitting terminal lens assembly 5402, for a better matching with the emitting terminal lens assembly 5402, which may be, for example, curved surfaces of the same lens curvature; in addition, in the parameters, the HFOV is 122°, the VFOV is 96°, and for the optical system for homogenizing and diffusing light, a post-homogenization collimation degree α2/pre-homogenization collimation degree α1=2.6. A focal length F_{T} of the emitting terminal lens assembly=2.8 mm; the number of light-emitting holes C in a single row channel in the horizontal direction=68; a diameter Le of a single light-emitting hole of the light source=32 μm; and F_{T}*2 tan(HFOV/2)/C/Le=4.643.

The rest of the implementation principles and technical effects are similar, and will be omitted herein in the present embodiment.

FIG. 55 shows a schematic structure diagram VII of an optical system for homogenizing and diffusing light provided by embodiments of the present disclosure. As shown in FIG. 55, the optical system for homogenizing and diffusing light includes a light source 5501, and an optical device 5502 for homogenizing and diffusing light, the optical device 5502 contains a plurality of block-shaped microlens units.

Detailed implementation of the optical system for homogenizing and diffusing light in the present embodiment can be referred to in the above system embodiment in FIG. 53, the difference is only that, in the present embodiment, there is no emitting terminal lens assembly, so HFOV, VFOV, and collimation degree parameters related to the emitting terminal lens assembly are not involved; since the optical device 5502 for homogenizing and diffusing light may control an angle and homogeneity of the light emitted by the light source 5501, it may directly play a role of homogenizing and diffusing on the light source 5501 without assistance of the emitting terminal lens assembly.

In addition, the radii of curvature of each block-shaped microlens unit in the present embodiment are approximately equal in the horizontal and vertical directions to ensure an equivalent degree of diffusion and homogenization. In the present embodiment, the light beam emitted by the light source 5501 is homogenized by the optical device 5502 for homogenizing and diffusing light, so as to realize compensation of dark zones caused by pixel defects in a light source emission area.

The present embodiment also provides an emitting apparatus, including the optical system for homogenizing and diffusing light.

Detailed implementation of the optical system for homogenizing and diffusing light in the present embodiment can be referred to in the above system embodiment, the implementation principles and technical effects are similar, and will be omitted herein in the present embodiment.

The foregoing is only a description of exemplary embodiments of the present disclosure, which is only used to illustrate the technical solution of the present disclosure, rather than limiting it; it should be noted that, for those of ordinary skill in the art, a number of improvements and substitutions can be made without departing from the technical principles of the present disclosure, and these improvements and substitutions should also be regarded as the scope of protection of the present disclosure.

What is claimed is:

1. An optical device for homogenizing and diffusing light, comprising a microlens array element, the microlens array element homogenizing and diffusing a light beam in a first direction, a second direction, or a first direction and a second direction, to form a homogeneous light beam, wherein the first direction and the second direction are perpendicular to each other.

2. The optical device for homogenizing and diffusing light according to claim 1, comprising:
one microlens array element, wherein the one microlens array element is configured for homogenizing and diffusing the light beam in the first direction, or in the second direction, or in the first direction and the second direction; or
two microlens array elements, which are a first microlens array element and a second microlens array element respectively, wherein the first microlens array element is configured for homogenizing and diffusing the light beam in the first direction, and the second microlens array element is configured for homogenizing the beam diffusing angle in the second direction.

3. The optical device for homogenizing and diffusing light according to claim 1, wherein the microlens array element comprises a plurality of microlens units arranged in an array, wherein, for each microlens unit, the microlens unit satisfies:
$$\vert R 1 \vert / \vert R 2 \vert \leq 10 ,$$
wherein, R1 is a radius of curvature of a surface of the microlens unit perpendicular to the second direction, and R2 is a radius of curvature of a surface of the microlens unit perpendicular to the first direction.

4. The optical device for homogenizing and diffusing light according to claim 1, wherein the microlens array element comprises a plurality of microlens units arranged in an array, wherein, for each microlens unit, the microlens unit satisfies:
$$0 < \vert F 1 / F 2 \vert \leq 5 ,$$
wherein, F1 is an effective focal length of the microlens unit in the first direction, and F2 is an effective focal length of the microlens unit in the second direction.

5. The optical device for homogenizing and diffusing light according to claim 1, wherein the microlens array element comprises a plurality of microlens units arranged in an array, wherein, for each microlens unit, the microlens unit satisfies:
2≤|R1/D1|≤100, wherein, R1 is a radius of curvature of a surface of the microlens unit perpendicular to the second direction, and D1 is an effective diameter of the microlens unit in the first direction; or
2≤|R2/D2|≤70, wherein, R2 is a radius of curvature of a surface of the microlens unit perpendicular to the first direction, and D2 is an effective diameter of the microlens unit in the second direction.

6. The optical device for homogenizing and diffusing light according to claim 1, wherein the microlens array element comprises a plurality of microlens units arranged in an array, wherein, for each microlens unit, the microlens unit satisfies:
2≤|R1/D1|100, wherein, R1 is a radius of curvature of a surface of the microlens unit perpendicular to the second direction, and D1 is an effective diameter of the microlens unit in the first direction; and
2≤|R2/D2|≤70, wherein, R2 is a radius of curvature of a surface of the microlens unit perpendicular to the first direction, and D2 is an effective diameter of the microlens unit in the second direction.

7. The optical device for homogenizing and diffusing light according to claim 1, wherein the microlens array element comprises a plurality of microlens units arranged in an array, wherein thicknesses of the microlens units are thickness random values, and the optical device for homogenizing and diffusing light satisfies:
dₘₐₓ/dₘᵢₙ≤2, wherein, dₘₐₓ is a maximum value in the thicknesses of the microlens units, and dₘᵢₙ is a minimum value in the thicknesses of the microlens units; or
a magnitude of variation d0 of a thickness random value from a preset thickness d satisfy: d0≤⅓*d.

8. The optical device for homogenizing and diffusing light according to claim 1, wherein the microlens array element comprises a plurality of microlens units arranged in an array, wherein,

|R1ₘₐₓ|/|R1ₘᵢₙ|≤1.5, wherein, R1ₘₐₓ is a maximum value in radii of curvature of surfaces of the microlens units perpendicular to the second direction, and R1ₘᵢₙ is a minimum value in the radii of curvature of the surfaces of the microlens units perpendicular to the second direction; or

|R2ₘₐₓ|/|R2ₘᵢₙ|≤1.5, wherein, R2ₘₐₓ is a maximum value in radii of curvature of surfaces of the microlens units perpendicular to the first direction, and R2ₘᵢₙ is a minimum value in the radii of curvature of the surfaces of the microlens unit perpendicular to the first direction.

9. The optical device for homogenizing and diffusing light according to claim 1, wherein the microlens array element comprises a plurality of microlens units arranged in an array, wherein,

|R1ₘₐₓ|/|R1ₘᵢₙ|≤1.5, wherein, R1ₘₐₓ is a maximum value in radii of curvature of surfaces of the microlens units perpendicular to the second direction, and R1ₘᵢₙ is a minimum value in the radii of curvature of the surfaces of the microlens units perpendicular to the second direction; and

|R2ₘₐₓ|/|R2ₘᵢₙ|≤1.5, wherein, R2ₘₐₓ is a maximum value in radii of curvature of surfaces of the microlens units perpendicular to the first direction, and R2ₘᵢₙ is a minimum value in the radii of curvature of the surfaces of the microlens unit perpendicular to the first direction.

10. The optical device for homogenizing and diffusing light according to claim 1, wherein the microlens array element comprises a plurality of microlens units arranged in an array, wherein central points of effective diameters of the plurality of microlens units in the first direction are not in a same plane; and the optical device for homogenizing and diffusing light satisfies:

|D3|≤⅓*D4, where D3 is a height difference between a central point of an effective diameter of a microlens unit in the first direction and a central point of a preset microlens unit diameter in the first direction, and D4 is the preset microlens unit diameter in the first direction; and
central points of effective diameters of the plurality of microlens units in the second direction are not in a same plane; and the optical device for homogenizing and diffusing light satisfies:

|D5|≤⅓*D6, where D5 is a height difference between a central point of an effective diameter of a microlens unit in the second direction and a central point of a preset microlens unit diameter in the second direction, and D6 is the preset microlens unit diameter in the second direction.

11. An emitting terminal, comprising:
a light source, configured to emit a light beam for detecting a target object; and
an optical device for homogenizing and diffusing light, configured to process the light beam emitted by the light source to obtain a diffused homogeneous beam.

12. The emitting terminal according to claim 11, wherein the optical device for homogenizing and diffusing light comprises a microlens array element, the emitting terminal further comprises an emitting terminal lens assembly disposed between the light source and the microlens array element, and the emitting terminal satisfies:
$$HFOV / ( \vert R 1 \vert / D 1 ) \leq 30 ° ,$$
wherein, HFOV is a horizontal field-of-view of the emitting terminal lens assembly, D1 is an effective diameter of a microlens unit in the microlens array element in a first direction, and R1 is a radius of curvature of a surface of the microlens unit perpendicular to a second direction.

13. The emitting terminal according to claim 11, wherein the optical device for homogenizing and diffusing light comprises a microlens array element, the emitting terminal further comprises an emitting terminal lens assembly disposed between the light source and the microlens array element, the light source is configured as a plurality of light-emitting channels in a second direction or a first direction, the light source comprises a plurality of sub-light sources arranged in an array, and the emitting terminal satisfies:
1≤α2/α1≤F_{T}×2×tan(HFOV/2)/(C/i)/Le, wherein, α1 is a collimation degree of a sub-light source before passing through the microlens array element, α2 is a collimation degree of the sub-light source after passing through the microlens array element, F_{T} is a focal length of the emitting terminal lens assembly, HFOV is a horizontal field-of-view of the emitting terminal lens assembly, C is a number of the sub-light sources contained in a light-emitting channel, i is a number of rows of the sub-light sources contained in the light-emitting channel in the second direction or a number of columns of the sub-light sources contained in the light-emitting channel in the first direction; Le is a maximum diameter of the sub-light source, wherein, 1≤F_{T}×2×tan(HFOV/2)/(C/i)/Le≤35.

14. An optical system, comprising:
the emitting terminal according to claim 11; and
a receiving terminal, comprising a detection array element, the detection array element receiving reflected light of the homogeneous beam.

15. The optical system according to claim 14, wherein,
the light source, configured to simultaneously emit at least two area light beams of a preset shape and perform cyclic scanning, a plurality of the area light beams of the preset shape being always non-adjacent to each other in the scanning process; or
the light source, configured to emit a single row/column of area light beam; or
the light source, configured to emit an area light beam of a shape for eliminating a distortion of an emitting terminal lens assembly.

16. The optical system according to claim 14, wherein, a ratio of an area of a receiving surface of the detection array element to a luminous area of the light source is n×m, wherein, 8≥n≥1 and 8≥m≥1.

17. The optical system according to claim 14, wherein,
the receiving terminal further comprises a receiving terminal lens assembly, the receiving terminal lens assembly converges the reflected light beam, the reflected light beam after converging is received by the detection array element, and the optical system satisfies:
0.3≤|Fθ_{TX}/Fθ_{RX}|≤3, wherein, Fθ_{TX} is a distortion of the emitting terminal lens assembly, and Fθ_{RX} is a distortion of the receiving terminal lens assembly.

18. The optical system according to claim 14, wherein, the optical device for homogenizing and diffusing light comprises a microlens array element, and the optical system satisfies:
0<L2/L1≤3, wherein, L1 is a distance from the light source to a surface of the microlens array element on a side away from the light source, and L2 is a distance from a receiving surface of a receiving terminal lens assembly to the detection array element.

19. The optical system according to claim 14, wherein, the emitting terminal comprises an emitting terminal lens assembly, and the emitting terminal lens assembly is configured to homogenize and diffuse the light beam emitted from the light source after adjusting a spacing to the emitting terminal, to obtain a diffused light beam.

20. The optical system according to claim 19, wherein, a collimation degree α3 before adjusting the spacing of the light source to the emitting terminal, a collimation degree α4 after adjusting the spacing of the light source to the emitting terminal, and a horizontal field-of-view HFOV of the emitting terminal lens assembly, a focal length F_{T} of the emitting terminal lens assembly, and defocus range d of the light source satisfy an irradiation area relationship:
$${F}_{T} * tan ( HFOV / 2 ) * d \leq α4 / α3 \leq {F}_{T} * tan ( HFOV / 2 ) / d ;$$
wherein, the collimation degree α3 before adjusting the spacing of the light source to the emitting terminal and the collimation degree α4 after adjusting the spacing satisfy a relationship:
$$1 \leq α4 / α3 \leq 120 ;$$
the focal length F_{T} of the emitting terminal lens assembly and the defocus range d of the light source satisfy a relationship:
$$d / {F}_{T} \leq 0.2 .$$
